(19) United States
(12) Patent Application Publication
(10) Pub. No.: US 2016/0055744 A1
(43) Pub. Date: Feb. 25, 2016

(54) SYSTEMS AND METHODS FOR TRAFFIC EFFICIENCY AND FLOW CONTROL

(71) Applicant: QUALCOMM Incorporated, San Diego, CA (US)

(72) Inventor: Christopher BRANSON, San Diego, CA (US)

(21) Appl. No.: 14/712,820

(22) Filed: May 14, 2015

Related U.S. Application Data
(60) Provisional application No. 62/039,364, filed on Aug. 19, 2014.

(51) Int. Cl. G08G 1/07

(52) U.S. Cl. CPC G08G 1/07

(57) ABSTRACT

Systems and methods are provided for managing traffic efficiency. The systems and methods involve receiving, at one or more mobile devices, vehicle information for one or more vehicles traveling in a transit system, the one or more mobile devices located in the one or more vehicles. The systems and methods involve transmitting, over one or more communications networks, the vehicle information from the one or more mobile devices to one or more remote servers that are configured to control one or more traffic control mechanisms based on the vehicle information.

### CROSS-REFERENCE TO RELATED APPLICATION(S)

This application claims the benefit of U.S. Provisional Application Ser. No. 62/039,364, entitled “SYSTEMS AND METHODS FOR TRAFFIC EFFICIENCY AND FLOW CONTROL” and filed on Aug. 19, 2014, which is expressly incorporated by reference herein in its entirety.

### BACKGROUND

1. Field

The present disclosure relates generally to communication systems and processes and more particularly to improving traffic efficiency with various flow control techniques.

2. Background

Modern transit systems include various roadways with traffic control mechanisms and vehicles passing thereupon. Traffic control mechanisms, such as stoplights, are typically controlled by timing sequences, in-road sensors, or other sensors along the roadway. In many cities, the transit system has become so overloaded with vehicles that considerable delays occur for anyone trying to pass through the transit system.

### SUMMARY

Embodiments relate to systems and methods for improving traffic efficiency.

According to an embodiment, a method of managing traffic efficiency is provided. The method includes receiving, at one or more mobile devices, vehicle information for one or more vehicles traveling in a transit system. In such embodiments, the one or more mobile devices are located in the one or more vehicles. The method further includes transmitting, over one or more communications networks, the vehicle information from the one or more mobile devices to one or more remote servers that are configured to control one or more traffic control mechanisms based on the vehicle information.

In some embodiments, the vehicle information includes a current location and a current velocity for each of the one or more vehicles.

In some embodiments, the current location and the current velocity for each of the one or more vehicles is determined based on a positioning system module provided in each of the one or more mobile devices.

In some embodiments, the one or more traffic control mechanisms are controlled to reduce a total waiting time for all vehicles of the one or more vehicles.

In some embodiments, the one or more traffic control mechanisms are controlled to prevent gridlock in at least one intersection in the transit system.

In some embodiments, the vehicle information comprises a current number of occupants for each of the one or more vehicles.

In some embodiments, the one or more traffic control mechanisms are controlled to reduce a total waiting time for all occupants in all vehicles of the one or more vehicles.

In some embodiments, the current number of occupants for each of the one or more vehicles is determined based on the total number of mobile devices in each of the one or more vehicles.

In some embodiments, the vehicle information comprises fuel consumption information for each of the one or more vehicles.

In some embodiments, the one or more traffic control mechanisms are controlled to reduce a total amount of fuel consumption for all vehicles of the one or more vehicles.

According to an embodiment, a mobile device apparatus for managing traffic efficiency is provided. The mobile device apparatus includes a receiver configured to receive, at the mobile device apparatus, vehicle information for a vehicle traveling in a transit system. In such embodiments, the mobile device apparatus is located in the vehicle. The mobile device apparatus further includes a transmitter configured to transmit, over one or more communications networks, the vehicle information from the mobile device apparatus to one or more remote servers that are configured to control one or more traffic control mechanisms based on the vehicle information.

In some embodiments, the vehicle information comprises a current location and a current velocity for the vehicle.

In some embodiments, the current location and the current velocity for the vehicle is determined based on a positioning system module provided in the mobile device apparatus.

In some embodiments, the one or more traffic control mechanisms are controlled to reduce a total waiting time for a plurality of vehicles traveling in the transit system.

In some embodiments, the one or more traffic control mechanisms are controlled to prevent gridlock in at least one intersection in the transit system.

In some embodiments, the vehicle information comprises a current number of occupants for the vehicle.

In some embodiments, the one or more traffic control mechanisms are controlled to reduce a total waiting time for all occupants in a plurality of vehicles traveling in the transit system.

In some embodiments, the current number of occupants for the vehicle is determined based on the total number of mobile devices in the vehicle.

In some embodiments, the vehicle information comprises fuel consumption information for the vehicle.

In some embodiments, the one or more traffic control mechanisms are controlled to reduce a total amount of fuel consumption for a plurality of vehicles traveling in the transit system.

According to an embodiment, a mobile device apparatus for managing traffic efficiency is provided. The mobile device apparatus includes means for receiving, at the mobile device apparatus, vehicle information for a vehicle traveling in a transit system. In such embodiments, the mobile device apparatus is located in the vehicle. The mobile device apparatus further includes means for transmitting, over one or more communications networks, the vehicle information from the mobile device apparatus to one or more remote servers that are configured to control one or more traffic control mechanisms based on the vehicle information.

In some embodiments, the vehicle information comprises a current location and a current velocity for the vehicle.

In some embodiments, the current location and the current velocity of the vehicle is determined based on a positioning system module provided in the mobile device apparatus.

In some embodiments, the one or more traffic control mechanisms are controlled to reduce a total waiting time for a plurality of vehicles traveling in the transit system.

In some embodiments, the vehicle information comprises a current number of occupants for the vehicle.

According to an embodiment, a non-transitory computer-readable medium is provided. The non-transitory computer-readable medium comprises instructions configured to cause one or more computing devices to receive, at one or more mobile devices, vehicle information for one or more vehicles traveling in a transit system. In such embodiments, the one or more mobile devices are located in the one or more vehicles. The instructions are configured to cause the one or more computing devices to transmit, over one or more communications networks, the vehicle information from the one or more mobile devices to one or more remote servers that are configured to control one or more traffic control mechanisms based on the vehicle information.

In some embodiments, the vehicle information comprises a current location and a current velocity for each of the one or more vehicles.

In some embodiments, the current location and the current velocity for each of the one or more vehicles is determined based on a positioning system module provided in each of the one or more mobile devices.

In some embodiments, the one or more traffic control mechanisms are controlled to reduce a total waiting time for all vehicles of the one or more vehicles.

In some embodiments, the vehicle information comprises a current number of occupants for each of the one or more vehicles.

### BRIEF DESCRIPTION OF THE DRAWINGS

FIG. 1 is a diagram showing various elements, including those as part of a transit system and traffic control system according to various embodiments of the present disclosure.

FIG. 2 is a flow chart of a process for traffic efficiency according to various embodiments of the disclosure.

FIG. 3A is a table showing vehicle information according to various embodiments of the disclosure.

FIG. 3B is a table showing flow control information according to various embodiments of the disclosure.

FIG. 4 is a diagram showing the use of vehicle information from FIG. 3A and flow control information from FIG. 3B to improve traffic efficiency according to various embodiments of the disclosure.

FIG. 5A is a table showing vehicle information according to various embodiments of the disclosure.

FIG. 5B is a table showing flow control information according to various embodiments of the disclosure.

FIG. 6 is a diagram showing the use of vehicle information from FIG. 5A and flow control information from FIG. 5B to improve traffic efficiency according to various embodiments of the disclosure.

FIG. 7A is a table showing vehicle information according to various embodiments of the disclosure

FIG. 7B is a table showing flow control information according to various embodiments of the disclosure.

FIG. 8 is a diagram showing the use of vehicle information from FIG. 7A and flow control information from FIG. 7B to improve traffic efficiency according to various embodiments of the disclosure.

FIG. 9 is a flow chart of a process for determining an occupant count according to various embodiments of the disclosure.

FIG. 10A is a table showing vehicle information according to various embodiments of the disclosure.

FIG. 10B is a table showing flow control information according to various embodiments of the disclosure.

FIG. 11 is a diagram showing the use of vehicle information from FIG. 10A and flow control information from FIG. 10B to improve traffic efficiency according to various embodiments of the disclosure.

FIG. 12A is a table showing vehicle information according to various embodiments of the disclosure.

FIG. 12B is a table showing flow control information according to various embodiments of the disclosure.

FIG. 13 is a diagram showing the use of vehicle information from FIG. 12A and flow control information from FIG. 12B to improve traffic efficiency according to various embodiments of the disclosure.

FIG. 14 is a flow chart of a process for traffic efficiency according to various embodiments of the disclosure.

FIG. 15A is a table showing vehicle information according to various embodiments of the disclosure.

FIG. 15B is a table showing flow control information according to various embodiments of the disclosure.

FIG. 15C is a table showing state change information according to various embodiments of the disclosure.

FIG. 16 is a diagram showing the use of vehicle information from FIG. 15A and flow control information from FIG. 15B to improve traffic efficiency according to various embodiments of the disclosure.

FIG. 17 is a flow chart of a process for traffic efficiency according to various embodiments of the disclosure.

FIG. 18 is a flow chart of a process for traffic efficiency according to various embodiments of the disclosure.

FIG. 19A is a table showing vehicle information according to various embodiments of the disclosure.

FIG. 19B is a table showing flow control information according to various embodiments of the disclosure.

FIG. 19C is a table showing route instruction information according to various embodiments of the disclosure.

FIG. 20 is a diagram showing the use of vehicle information from FIG. 19A and flow control information from FIG. 19B to improve traffic efficiency according to various embodiments of the disclosure.

FIG. 21 is a flow chart of a process for traffic efficiency according to various embodiments of the disclosure.

FIG. 22 is a functional block diagram of a mobile device according to various embodiments.

FIG. 23 is a flow chart of a process for traffic efficiency according to various embodiments of the disclosure.

### DETAILED DESCRIPTION

Embodiments relate to systems and methods for to improving traffic efficiency with various flow control techniques.

The detailed description set forth below in connection with the appended drawings is intended as a description of various configurations and is not intended to represent the only configurations in which the concepts described herein may be practiced. The detailed description includes specific details for providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof whether such elements are implemented as hardware or software depends upon the particular application and design constraints imposed on the overall system.

By way of example, an element, or any portion of an element, or any combination of elements may be implemented with “processing electronics” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

In the following disclosure, some terms may be used with special meaning to the present embodiments. The term “transit system” is used. In some embodiments, a “transit system” is an all-inclusive definition for roadways, vehicles, traffic control mechanisms, and all other elements that combine to form a system of transit. The term “traffic control mechanism” is used. In some embodiments, a “traffic control mechanism” is used to refer to any way in which traffic is controlled or restricted, including stoplights, stop signs, flow control lights (such as on a freeway entry ramp), express lanes (such as restricted exit lanes), occupancy restriction lanes (such as High Occupancy Vehicle lanes), payment restriction lanes (such as toll lanes), combination occupancy and payment restriction lanes (such as High Occupancy Toll lanes), reversible lanes, and turn restrictions on lanes at an intersection. The term “traffic control system” is used. In some embodiments, a “traffic control system” is used to refer to any combining of numerous traffic control mechanisms into a central or distributed form of control.

Embodiments improve on present day transit systems, traffic control systems, and traffic control mechanisms. In many places, modern day transit systems do not effectively manage the large volume of vehicles passing through the transit system. While this volume is itself a challenge, certain inefficiencies in the traffic control systems and traffic control mechanisms exacerbate this problem.

Modern traffic control systems are imperfect. In many cases, a traffic control mechanism is not part of any traffic control system, such as a stoplight that is not coordinated in any way with proximate stoplights. Some cities may provide a traffic control system in the form of a synchronized light sequence for a group of stoplights in close proximity. However, where used, this synchronization only covers small areas, such as a few stoplights, a highly commercial stretch of a street, or a small business district. This synchronization never covers an entire metropolitan area. Furthermore, such a traffic control system is highly rudimentary, as it is based largely on predefined timing sequences that do not reflect actual traffic conditions at any particular point in time.

Modern traffic control mechanisms are imperfect. Most traffic control mechanisms are controlled based on rudimentary techniques, such as a timing sequence, a time of day, or a simple in-road or on-road sensor. For example, many stoplights are controlled by a fixed timing sequence. While this timing sequence may change based on the time of day to reflect expected changes in traffic volume, this timing sequence is predefined and not based on actual traffic conditions at any particular point in time. As another example, many stoplights are controlled by inductance sensors embedded under the pavement for various lanes, especially for left turn lanes. While such sensors may be used to determine that a car is or is not present, and thus that a left turn stoplight should change from red to green, such sensors do not provide information as to how many cars are waiting in that lane. As such, if the left turn stoplight is changed to green, it is held in that state for a predefined fixed length of time that does not reflect actual traffic conditions at that particular point in time. While various other techniques can be used to control traffic control mechanisms, all are fairly rudimentary in that they are fixed based on predictions of traffic patterns that do not reflect real-time traffic conditions.

Embodiments improve the efficiency of traffic control mechanisms and the traffic control system by using information provided by automobiles and their passengers that are in transit. With information provided in real-time by current travelers on the roadway, the traffic control system can control the traffic control mechanisms based on accurate information about current traffic flows.

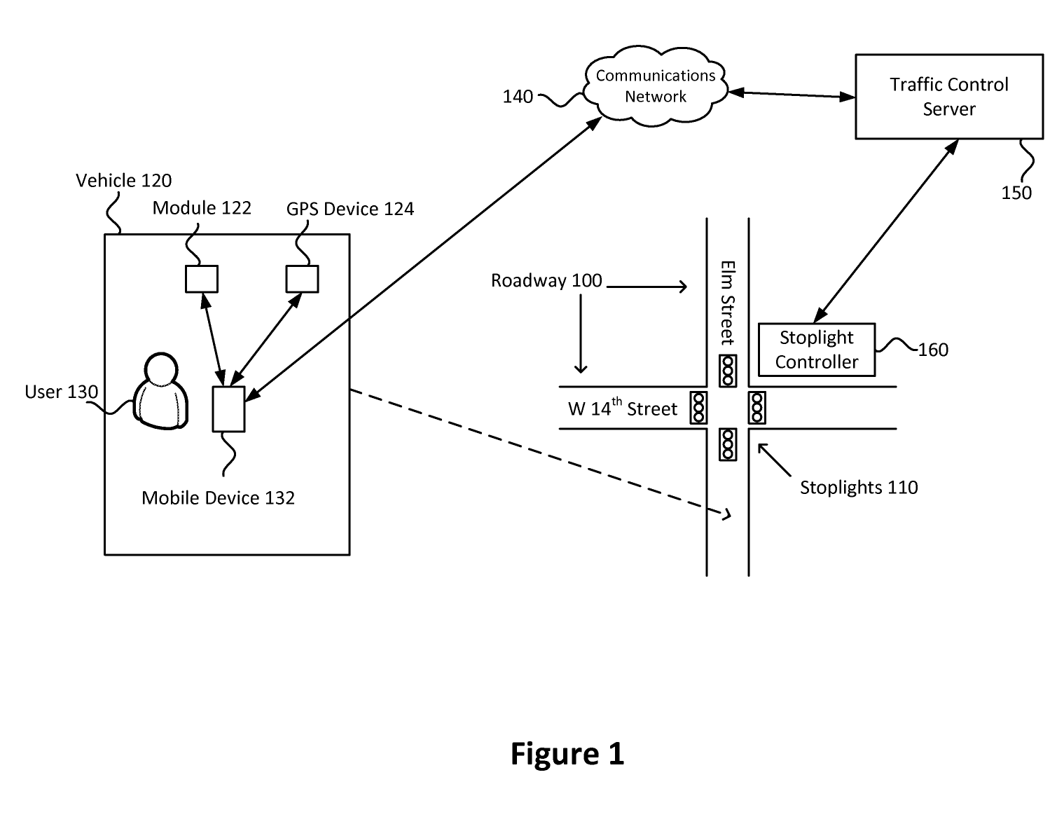

FIG. 1 is a diagram showing various elements, including those as part of a transit system and traffic control system according to various embodiments of the present disclosure. A roadway 100, stoplights 110, vehicle 120, user 130, communications network 140, traffic control server 150, and stoplight controller 160 are shown. The vehicle 120 has contained therein a module 122 and a Global Positioning System (GPS) device 124. The user 130 has a mobile device 132.

As shown, a roadway 100 is provided. Roadway 100 is shown as consisting of segments of Elm Street and W 14^{th} Street. This is an exemplary embodiment intended to show a particular application of the techniques of the present disclosure, and in other embodiments of the traffic control system, the roadway preferably consists of many more road segments over a much larger area than that shown for roadway 100.

As shown, four stoplights 110 are provided. Stoplights 110 are provided at the intersection of Elm Street and W 14^{th} Street of roadway 100. In this case, each stoplight of stoplights 110 is provided to control the flow of traffic flowing into the intersection from one of the road segments. This is an exemplary embodiment intended to show a particular application of the techniques of the present disclosure, and in other embodiments of the traffic control system, various other forms of stoplights and other traffic control mechanisms are preferably provided along the roadway.

As shown, vehicle 120 is provided. As indicated by the dashed line and arrow, vehicle 120 is in transit or otherwise travelling along Elm Street of roadway 100. As such, vehicle 120 makes up a part of the traffic flow in the transit system. Therefore, information about vehicle 120 may be useful for determining how to maximize efficiency of traffic flow through the transit system. Vehicle 120 may be any sort of vehicle that travels through the transit system, such as a car, a truck, a private bus, a public transit bus, a tractor trailer type truck, a motorcycle, etc.

Vehicle 120 is shown having a module 122 and a GPS device 124 provided therein. Module 122 is a generic indicator for a communication and/or sensor module that may be installed in vehicle 120 or otherwise placed in vehicle 120. Module 122 may be used to detect or otherwise to receive various information about vehicle 120. The type of information that module 122 may detect or receive is discussed later in the present disclosure. As shown, module 122 is configured to communicate with mobile device 132. This communication may be performed in order to provide the information detected or received by module 122 to mobile device 132. This communication may be performed in order to provide information about the transit system and its traffic control mechanisms from mobile device 132 to module 122. This communication may be implemented with any of a variety of communication technologies, such as a Bluetooth connection. GPS device 124 may be installed as part of vehicle 120 or otherwise placed in vehicle 120 by user 130 or another party. GPS device 124 may be a handheld GPS device that the user 130 uses to find and to navigate a route from some starting destination to a desired terminal destination. GPS device 124 may be part of an infotainment system provided as part of vehicle 120 that the user 130 uses to find and to navigate a route from some starting destination to a desired terminal destination. As shown, GPS device 124 is configured to communicate with mobile device 132. This communication may be performed in order to provide route, location, or other information from GPS device 124 to mobile device 132. This communication may be performed in order to provide route location from mobile device 132 to GPS device 124. This communication may be implemented with any of a variety of communication technologies, such as a Bluetooth connection.

As shown, a user 130 is present in vehicle 120. The user 130 may be a driver of vehicle 120, a passenger, or otherwise present in vehicle 120. User 130 is shown to be in possession of mobile device 132. Mobile device 132 may be any of a variety of electronic devices capable of communicating over a communications network, such as communications network 140. For example, mobile device 132 may be a mobile telephone, smartphone, cellular telephone, some other telephone, a tablet computer, laptop computer, etc. In some embodiments, mobile device 132 may be easily removable from a vehicle by a user of the vehicle and/or mobile device 132. In some embodiments, mobile device 132 may be fixedly attached or installed in a vehicle. Mobile device 132 may have built in modules capable of sensing or receiving various information in addition to the information received from module 122 and GPS device 124. For example, mobile device 132 may contain a GPS module that is capable of determining a present location and present velocity for the mobile device 132 (and by association for vehicle 120) at any particular point in time. As another example, mobile device 132 may contain one or more user input modules, such as a touchscreen display and associated GUI interface. This user input module may be used to receive information, such as a user of vehicle identifier from the user 130. Other such modules may be provided in mobile device 132.

As shown, a communications network 140 is provided. As further shown, communications network 140 is in communication with mobile device 132 and traffic control server 150. This configuration may be provided so that mobile device 132 can transmit vehicle information to traffic control server 150 via communications network 140. The vehicle information so transmitted may include the information provided from module 122 to mobile device 132, the information provided from GPS device 124 to mobile device 132, and the information detected or received based on some module of mobile device 132. In some embodiments, communications network 140 may be implemented as a communications network. In some embodiments, communications network 140 may be implemented as any wide area network (“WAN”).

As shown, a traffic control server 150 is provided. Traffic control server 150 may be configured to receive the vehicle information described supra regarding various vehicles in the transit system, such as about vehicle 120 and other similar vehicle on roadway 100. While the vehicle information could be received about the vehicles by other techniques, in some embodiments, this vehicle information is received via a mobile device present in each of the vehicles and via a communications network. In this way, the existing technology infrastructure of mobile devices and communications networks can be leveraged to receive vehicle information at traffic control server 150. This may be beneficial so as to make the system incorporating traffic control server 150 easier to implement, lower cost, and more likely to be implemented given that some existing communication infrastructure can be utilized. In some embodiments, traffic control server 150 may be provided remote from the traffic control mechanisms of the transit system. In this way, traffic control server 150 may receive vehicle information from a wide area communications network and control numerous traffic control mechanisms without needing to be co-located with any or all of the traffic control mechanisms.

Traffic control server 150 may be provided so as to process the vehicle information in order to determine flow control information. In one embodiment, the traffic control server 150 processes the vehicle information received about vehicle 120 in nearly real-time so as to determine when stoplights 110 should change between various states.

Flow control information may be various forms of information that can be used to control traffic flow in the transit system, such as by controlling traffic control mechanisms based on the flow control information. For example, flow control information may be a set of summaries or predictions of traffic volume at particular places in the transit system. For instance, the flow control information may include a summary or prediction of the number of vehicles waiting at the intersection of Elm Street and W 14^{th} Street on the segment of Elm Street flowing from bottom to top (as depicted). As another example, flow control information may be a set of instructions defining how some particular traffic control mechanisms should be controlled. For instance, the flow control information may include an instruction that essentially states “stoplight on lower portion of Elm Street at intersection of Elm Street and W 14^{th} Street should change from red to green in 15 seconds.” As another instance, the flow control information may include an instruction that essentially states “all stoplights at the intersection of Elm Street and W 14^{th} Street should change between stop state and go state at <TIMESTAMP>.” Here, <TIMESTAMP> may be a particular absolute time at some point in the near future, such as being defined by a day, hour, minute, and second. Other forms of flow control information consistent with the present disclosure are possible.

Reference is made in the present disclosure to a stop state and a go state for various traffic control mechanisms. A stop state refers generally to a traffic control mechanism not allowing particular vehicles to proceed. For example, a red light may be a stop state for a stoplight. A go state refers generally to a traffic control mechanism allowing particular vehicles to proceed. Other states for traffic control mechanisms may exist, or those states may be incorporated into the stop state and go state. For example, a yellow light for a stoplight could be considered a caution state independent of a stop state and a go state for the stoplight. However, the yellow light could be considered part of the go state, given that vehicles are generally allowed to proceed on a yellow light that succeeds a green light and precedes a red light. Alternatively, a yellow light that succeeds a red light and precedes a green light, as is used in some countries, may be considered part of a stop state given that vehicles are generally not allowed to proceed on such a yellow light.

Although traffic control server 150 is shown as a single server in this exemplary embodiment, other configurations may be provided consistent with the present disclosure. For example, embodiments consistent with the present disclosure may include more than one server for performing the operations described with respect to traffic control server 150 above. As another example, embodiments consistent with the present disclosure may include one or more servers for receiving vehicle information via the communications network, some other one or more servers for processing the traffic control information, and some other one or more servers for transmitting flow control information. In other embodiments, computing devices may be used that may not be generally described as servers but that performs similar operations described with respect to traffic control server 150 above.

As shown, a stoplight controller 160 is provided. Stoplight controller 160 may be a computing device provided to control the state of the various stoplights of stoplights 110. For example, stoplight controller 160 may be a computing device that resides adjacent to the intersection of Elm Street and W 14^{th} Street. In such a situation, stoplight controller 160 may control stoplights 110 via a wired or wireless connection to the stoplights 110. As shown, stoplight controller 160 is configured to communicate with traffic control server 150. This communication may be performed in order to provide stoplight controller 160 the flow control information generated by traffic control server 150 and thereby control stoplights 110 using that flow control information. This communication between traffic control server 150 and stoplight controller 160 may be implemented with any of a variety of communication technologies, such as with a cellular connection. For example, where the flow control information is an instruction to change the state of stoplights 110 at <TIMESTAMP>, stoplight controller 160 may receive that flow control information from traffic control server shortly prior to <TIMESTAMP>. Stoplight controller 160 may then wait until a local clock indicates that <TIMESTAMP> has been reached. Stoplight controller 160 may then change the states of stoplights 110 as instructed by the received flow control information.

Using the elements just described, in some embodiments various forms of efficiency in the transit system may be improved by controlling traffic control mechanisms based on real-time information about actual traffic flow in the transit system. These efficiencies may be further improved given that this real-time information may be received and processed for a large portion of or all of the transit system at a central point of analysis. Having centralized information about a large portion of or all of the transit system may allow more efficient control of the traffic control mechanisms than would be possible with local, greedy algorithm style decisions made at a per-intersection or other small scale level.

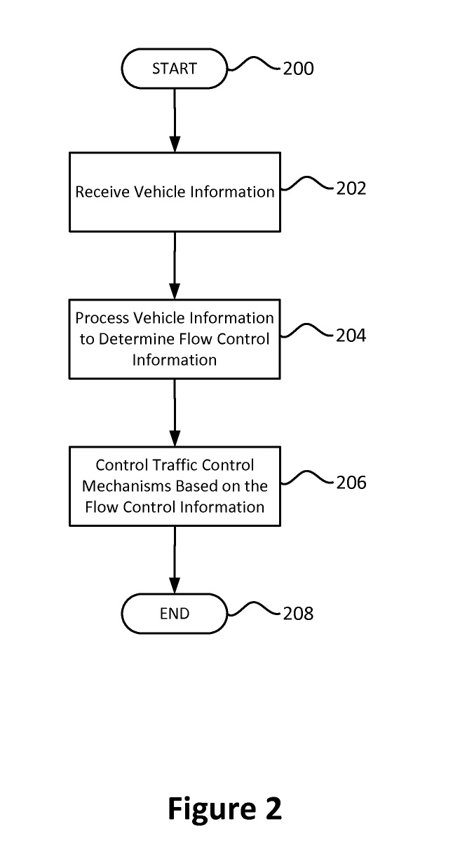

FIG. 2 is a flow chart of a process for traffic efficiency according to various embodiments of the disclosure. The process begins at block 200.

At block 202, vehicle information is received. A central computing device, such as traffic control server 150, may perform this block. The vehicle information may include various types of information about various vehicles traveling in a transit system. The vehicle information may be received via a communications network from various cellular-enabled devices present in those various vehicles.

At block 204, vehicle information is processed to determine flow control information. A central computing device, such as traffic control server 150, may perform this block. The flow control information may be various forms of information as described elsewhere in the present disclosure. The vehicle information may be processed to generate the flow control information in order to improve some efficiencies in traffic flow through the transit system, as described elsewhere in the present disclosure.

At block 206, traffic control mechanisms are controlled based on the flow control information. A central computing device, such as traffic control server 150, or various distributed computing devices, such as stoplight controller 160, may perform this block. Controlling the traffic control mechanism may involve changing a state of the traffic control mechanism or maintaining a state of the traffic control mechanism.

At block 208, the process ends.

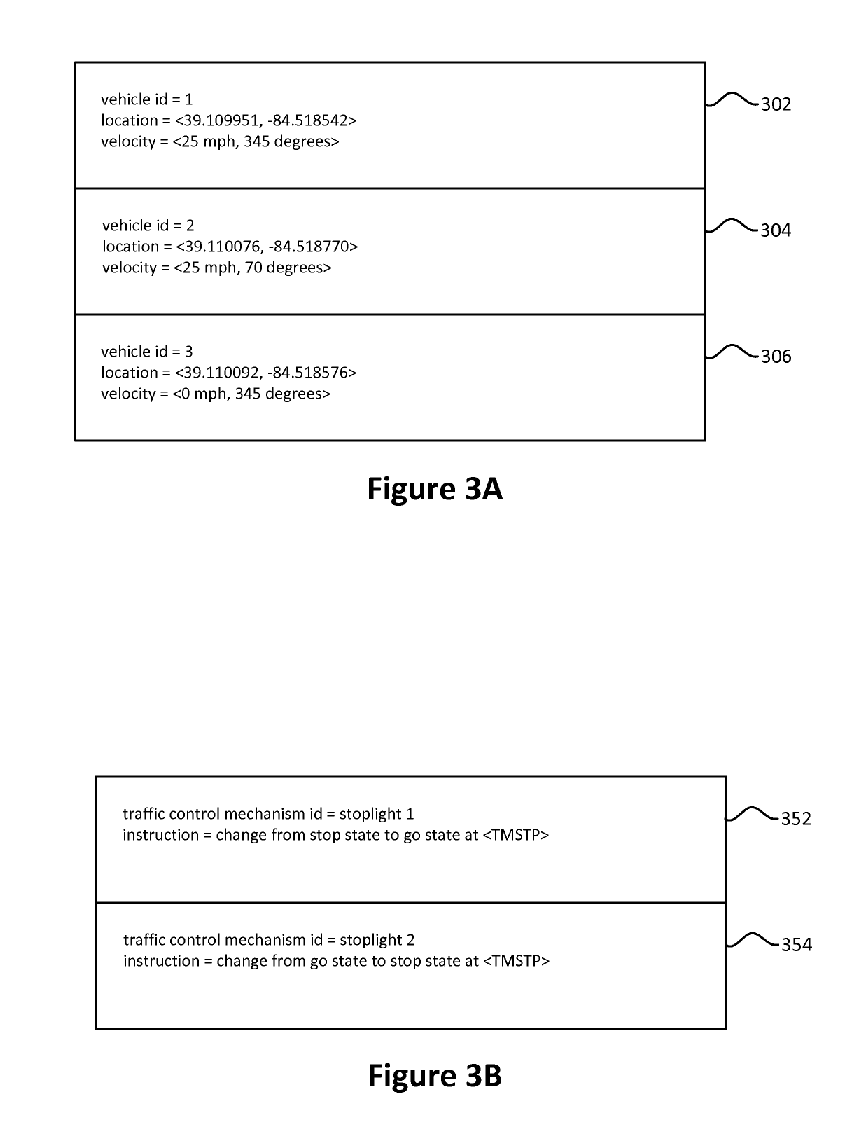

FIG. 3A is a table showing vehicle information according to various embodiments of the disclosure. In the embodiment shown in this figure, three elements of information are included in the vehicle information: a vehicle identifier, a location of the vehicle, and a velocity of the vehicle. This vehicle information may be transmitted from mobile devices located in the various vehicles to a traffic control server of a traffic control system as previously discussed. Vehicle information 302, 304, and 306 are shown as relating to three different vehicles.

The vehicle identifier may be a unique identifier for the vehicle or user. For example, the vehicle identifier may be a globally unique identifier that exists to uniquely identify the vehicle without respect to the traffic control system. In such a case the Vehicle Identifier Number (“VIN”) may be used. As another example, the vehicle identifier may be a unique identifier for the vehicle as assigned by the traffic control system. The vehicle identifier may be assigned to the vehicle during a registration process performed by the user. As another example, the vehicle identifier may uniquely identify the user to whom the mobile device belongs. Other forms of information may be used for the vehicle identifier, so long as it identifies the vehicle as distinct from other vehicles present in the transit system.

The information as to the location of the vehicle may indicate a position on the earth's surface where the vehicle is present. For example, the location information may indicate a latitude and longitude of the vehicle. In an aspect, the location information may be received from a GPS module of a mobile device that is present in a vehicle. Alternatively, this information may be received from a GPS device separately present in the vehicle or from some other positioning module present in the mobile device or separately present in the vehicle.

The information as to the velocity of the vehicle may indicate a speed of the vehicle and a direction on the earth's surface in which the vehicle is travelling. For example, the velocity information may indicate a speed in miles per hour that the vehicle is traveling and a heading angle defining the direction in which the vehicle is traveling. The heading angle may be a right-hand angle of offset from a heading of perfect north. While this example is shown and discussed, any other form of velocity information indicating the velocity of the vehicle may be used.

FIG. 3B is a table showing flow control information according to various embodiments of the disclosure. In the embodiment shown in this figure, two elements of information are included in the flow control information: a traffic control mechanism identifier and an instruction. Flow control information 352 and 354 are shown. The traffic control mechanism identifier may indicate a particular traffic control mechanism that is to be controlled by the flow control information. The instruction may indicate an action that is to be performed for the identified traffic control mechanism. The instruction may be effective to control the traffic control mechanism or may be used by an intermediate device to control the traffic control mechanism. In the example shown in this figure, two particular stoplights are to change between the stop state and go state at <TMSTP>. Here, <TMSTP> is an identifier of a particular point in time as previously discussed for the similarly labeled <TIMESTAMP> value.

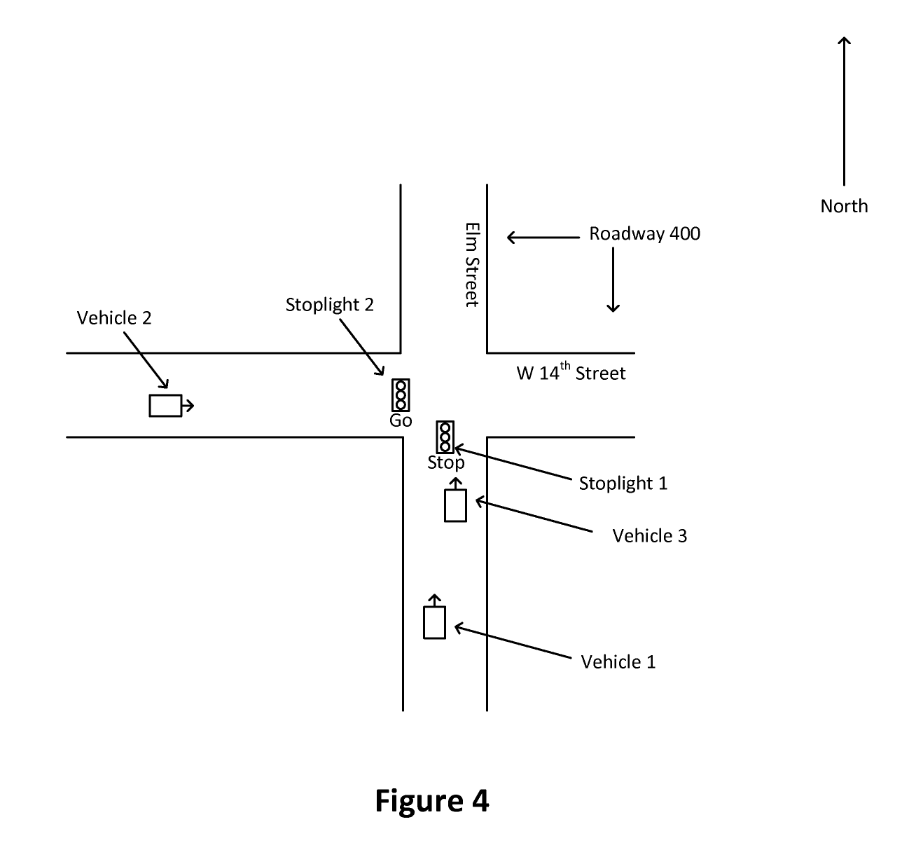

FIG. 4 is a diagram showing the use of vehicle information from FIG. 3A and flow control information from FIG. 3B to improve traffic efficiency according to various embodiments of the disclosure. A roadway 400 containing segments of Elm Street and W 14^{th} Street is shown. An indicator of the North direction is shown, which may correspond with a zero degree heading angle. In the example shown, Elm Street and W 14^{th} Street are both one-way streets, flowing north to south and west to east, respectively. At the intersection of these two streets, Stoplight 1 controls the flow of traffic from the lower portion of Elm Street in the northward direction. Stoplight 2 controls the flow of traffic from the left portion of W 14^{th} Street in the eastward direction.

In the scenario shown in FIG. 4, various vehicles and traffic control mechanisms are active in the transit system. Stoplight 1 is in a stop state (red light). Stoplight 2 is in a go state (green light). With reference to FIG. 3A, it can be seen that vehicle 1 is traveling north on Elm Street at 25 MPH. Vehicle 2 is traveling east on W 14^{th} Street at 25 MPH. Vehicle 3 is traveling north on Elm Street at 0 MPH. The velocity and location of vehicle 3 indicate that it is waiting at the intersection of Elm Street and W 14^{th} Street based on the stop state of stoplight 1.

Based on receiving the vehicle information shown in FIG. 3A, a traffic control server or other computing device may process the vehicle information in order to determine or to generate the flow control information shown in FIG. 3B. In particular, when processing the vehicle information, the traffic control server may determine based on the location and velocity information that two vehicles (vehicle 1 and vehicle 3) are approaching the intersection of Elm Street and W 14^{th} Street from Elm Street. The traffic control server may determine based on the location and velocity information, however, that only one vehicle (vehicle 2) is approaching the intersection of Elm Street and W 14^{th} Street from W 14^{th} Street. Therefore, a stop state for stoplight 1 produces a total wait time for the transit system of two vehicles, while a stop state for stoplight 2 produces a total wait time for the transit system of one vehicle. As such, the traffic control server may determine that stoplight 1 and stoplight 2 should change state. Based on this determination, traffic control server may generate the flow control information shown in FIG. 3B. The traffic control server may determine the <TMSTP> as a point in time almost immediately in the future from the current time so that the efficiency improvements of the stoplight state changes can be immediately achieved. The traffic control server may then transmit the flow control information directly to stoplights 1 and 2, or to an intermediate controller device that can execute the instructions.

Using the techniques just described, a traffic control system may use location and velocity information received from mobile devices present in various vehicles in order to determine flow control information that will reduce total waiting time for all vehicles. Though this example was shown with respect to a single intersection, the techniques can be extrapolated to an entire transit system of many intersections, many road segments, many vehicles, and many traffic control mechanisms in order to improve the total wait time efficiency for all vehicles in the entire transit system.

In some embodiments, the traffic control server may factor worst case management into the calculations of total wait time or other calculations described elsewhere in the present disclosure. While minimizing total wait time as viewed on a macro scale for all vehicles in the transit system may be generally beneficial, the traffic control system may need to avoid causing excessive delays to any particular vehicles in the transmit system. In some cases where total wait time of all vehicles is minimized, the wait time of a particular vehicle may reach excessive levels. An example can be considered with respect to FIG. 4. Based on the state changes to stoplights 1 and 2, vehicle 2 may need to wait at the intersection. If, while vehicle 2 is waiting at the intersection, a continuous stream of never fewer than two vehicles approaches the intersection traveling north on Elm Street, the traffic control server may never change the state of stoplights 1 and 2 because the total wait time may be reduced with traffic flowing through the intersection on Elm Street. Therefore, vehicle 2 may wait an excessive amount of time at the intersection. In order to avoid this, traffic control server may monitor the wait time of vehicle 2 and change the state of stoplights 1 and 2 if a threshold of worst case wait time is met. In this way, traffic control mechanisms may generally be controlled to achieve minimal total wait time on the macro scale, while considerations of worst case management on the micro scale may cause occasional deviations.

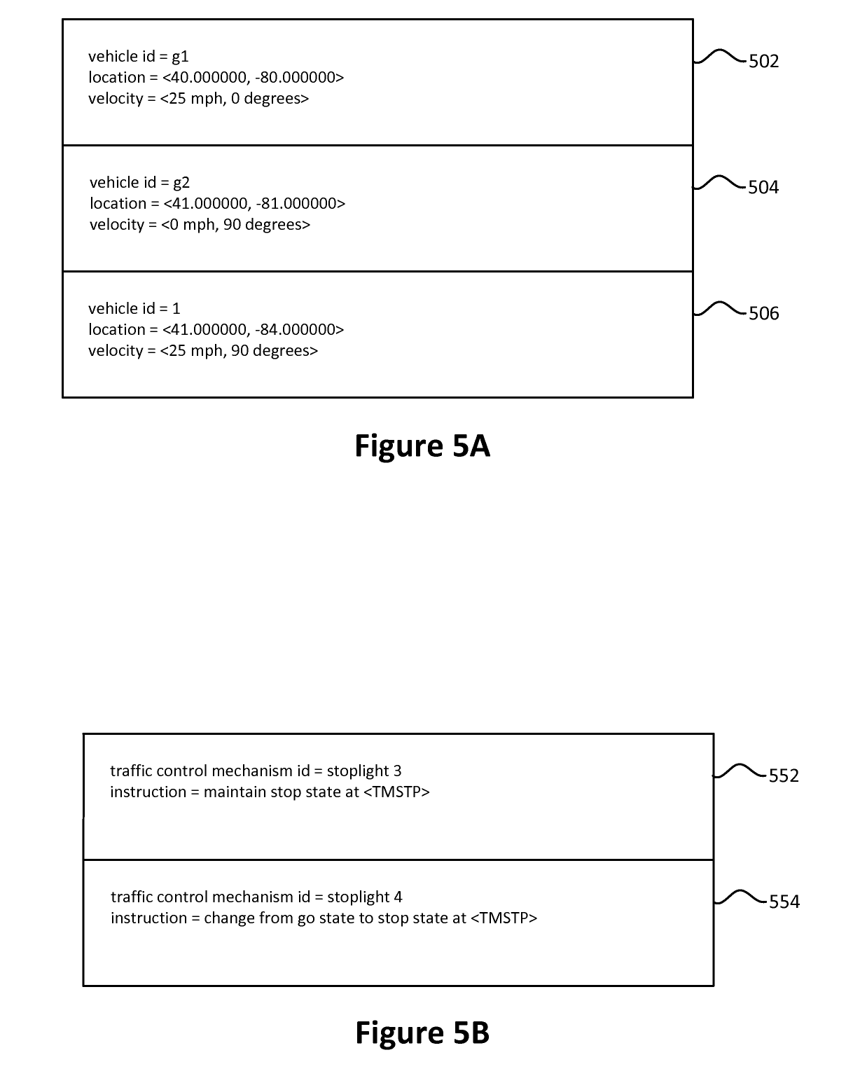

FIG. 5A is a table showing vehicle information according to various embodiments of the disclosure. In the embodiment shown in this figure, three elements of information are included in the vehicle information: a vehicle identifier, a location of the vehicle, and a velocity of the vehicle. This vehicle information may be transmitted from mobile devices located in the various vehicles to a traffic control server of a traffic control system as previously discussed. This vehicle information may be substantially the same in form as that discussed with respect to FIG. 3A. Vehicle information 502, 504, and 506 are shown as relating to three different vehicles.

FIG. 5B is a table showing flow control information according to various embodiments of the disclosure. In the embodiment shown in FIG. 5B, two elements of information are included in the flow control information: a traffic control mechanism identifier and an instruction. This flow control information may be substantially the same in form as that discussed with respect to FIG. 3B. Flow control information 552 and 554 are shown.

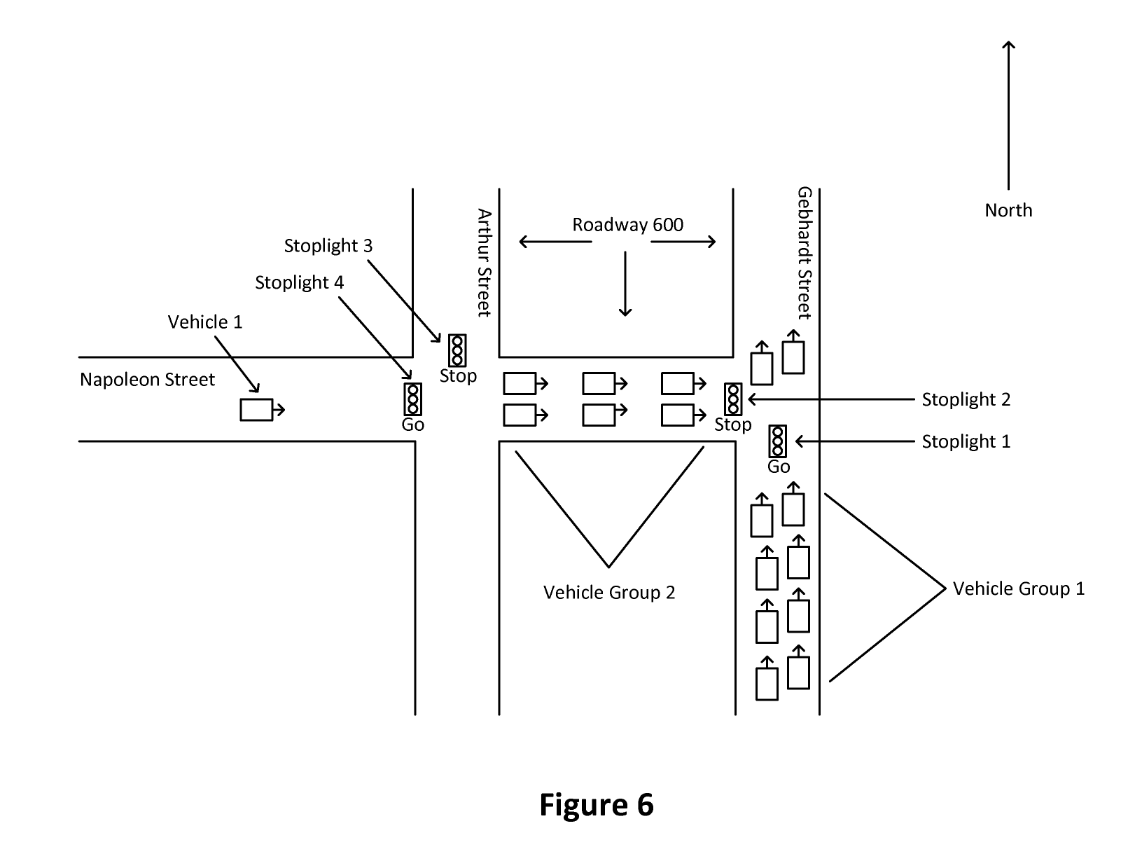

FIG. 6 is a diagram showing the use of vehicle information from FIG. 5A and flow control information from FIG. 5B to improve traffic efficiency according to various embodiments of the disclosure. A roadway 600 containing segments of Napoleon Street, Arthur Street, and Gebhardt Street is shown. An indicator of the North direction is shown, which may correspond with a zero degree heading angle. In the example shown, all streets are one-way streets, with Napoleon Street flowing west to east, Arthur Street flowing north to south, and Gebhardt Street flowing south to north. Stoplights 1, 2, 3, and 4 are shown controlling the flow of traffic through the various intersections as shown.

In the scenario shown in this diagram, various vehicles and traffic control mechanisms are active in the transit system. Vehicle group 1 consists of eight vehicles traveling north on Gebhardt Street through the intersection with Napoleon Street. This group of vehicles is passing through the intersection based on the go state of stoplight 1. Vehicle group 2 consists of six vehicles traveling east on Napoleon Street and waiting at that intersection based on the stop state of Stoplight 2. Vehicle 1 is traveling east on Napoleon Street and approaching the intersection with Arthur Street. Based on the go state of stoplight 4, vehicle 1 would pass into the intersection once it is reached. Stoplight 3 is in a stop state. For the scenario shown, vehicle information 502 may correspond to a vehicle in vehicle group 1. Vehicle information 504 may correspond to a vehicle in vehicle group 2. Vehicle information 506 may correspond to a vehicle 1.

The configuration of the stoplight states shown in FIG. 6 may have arisen or otherwise be consistent with the total wait time minimization techniques previously described. In particular, stoplight 1 will have the go state and stoplight 2 will have the stop state because there are more vehicles approaching the intersection of Gebhardt Street and Napoleon Street from the lower portion of Gebhardt Street. Stoplight 3 will have the stop state and stoplight 4 will have the go state because there are more vehicles approaching the intersection of Arthur Street and Napoleon Street from the left portion of Napoleon Street.

However, while the configuration of stoplight states shown in FIG. 6 may correspond during a basic analysis with a most efficient configuration based on total wait time, processing of the vehicle information may involve identifying other potential impediments to traffic efficiency. In particular, when processing the vehicle information, the traffic control server may attempt to prevent or reduce gridlock in the transit system. Gridlock is generally defined as the situation where the volume of vehicles waiting at one intersection is large enough that the line of vehicles spills back into the previous intersection, thereby preventing cross traffic from passing through that previous intersection.

As applied to the scenario depicted in FIG. 6, the traffic control mechanisms may be controlled to prevent gridlock in the intersection of Arthur Street and Napoleon Street. When processing the vehicle information, the traffic control server may determine that the tail end of vehicle group 2 has already reached the previous intersection (Arthur Street and Napoleon Street) and that stoplight 2 will not be changing to a go state in the immediate future. Furthermore, the traffic control server may determine that vehicle 1 is approaching the previous intersection (Arthur Street and Napoleon Street) and as such could cause gridlock if it passes into that intersection. Therefore, the traffic control server may determine that stoplight 4 should change to a stop state, thereby generating traffic control information 554. While it may not be necessary, the traffic control server may also generate traffic control information 552 so as to verify that stoplight 3 will remain in a stop state. The traffic control server may then transmit the flow control information to the affected traffic control mechanisms or to an intermediate controller device that can execute the instructions.

Using the techniques just described, a traffic control system may use location and velocity information received from mobile devices present in various vehicles in order to prevent or reduce gridlock in the transit system.

In some embodiments, techniques similar to those just described may be used to remove gridlock once it has occurred. For example, if gridlock has already occurred at the intersection of Arthur Street and Napoleon Street, the traffic control system may hold stoplights 3 and 4 in stop states until the gridlock has been removed.

In some embodiments, techniques similar to those just described may be used to prevent similar flow control problems in the transit system. For example, it sometimes occurs with conventional transit systems that an undesirable asymmetry in traffic flow occurs between two different road segments feeding into a single outbound road segment. For example, a left turn lane from southbound Arthur Street and a straightaway lane from eastbound Napoleon Street may both feed traffic into the eastbound segment of Napoleon Street between its intersections with Arthur Street and Gebhardt Street. Using conventional static timing sequences for stoplights 1, 2, 3, and 4, it is possible that traffic from the straightaway portion of Napoleon Street always fills the entire eastbound segment of Napoleon Street between its intersections with Arthur Street and Gebhardt Street while stoplight 4 is in a go state. Then, these vehicles remain in that eastbound segment of Napoleon Street while stoplight 2 is in a stop state. Then, for the entire duration that stoplight 3 is in a go state for the left turn lane from southbound Arthur Street, there is no space for vehicles to enter the eastbound segment of Napoleon Street between its intersections with Arthur Street and Gebhardt Street. Therefore, the traffic on southbound Arthur Street attempting to turn left onto eastbound Napoleon street will either have to actively cause gridlock or will repeatedly sit through green light and red lights for stoplight 3 without being able to advance. In order to prevent this situation, the traffic control system may only allow a go state for stoplight 4 and stoplight 3 so that each of those feeder road segments feed a proportional amount of traffic into the portion of eastbound Napoleon Street in contention. By determining the total number of vehicles waiting to enter that portion of Napoleon Street, and the portion of that total attributable to each of southbound Arthur Street and eastbound Napoleon Street, the traffic control system can assure equitable wait times in these situations and thereby prevent undesirable asymmetry in traffic flow.

In some embodiments, additional elements of information available as part of the vehicle information may be used to enhance the gridlock prevention techniques just described. For example, information about a current state of the turn signals for a particular vehicle may be provided as part of the vehicle information. This turn signal state information may be gathered by a custom module, such as module 122 previously described, that is installed in the vehicle. The information can then be transmitted via the mobile device present in the vehicle to the traffic control server along with the other vehicle information. Turn signal state information can be used to more accurately determine when gridlock or undesirable asymmetry in traffic flow will occur. For instance, in the scenario described with respect to FIG. 6, information from vehicle 1 about the state of the turn signal may allow a better determination of whether gridlock will actually occur. If the turn signal state is that of indicating an imminent right turn, then it may be more likely that vehicle 1 will turn right onto Arthur Street and thereby not cause gridlock even with stoplight 4 in a go state. To the contrary, if the turn signal state is that of indicating no imminent turns, then it may be more likely that vehicle 1 will proceed straight on Napoleon Street and thereby causing gridlock unless stoplight 4 is changed to a stop state. Other elements of vehicle information may be used to enhance these techniques consistent with the present disclosure.

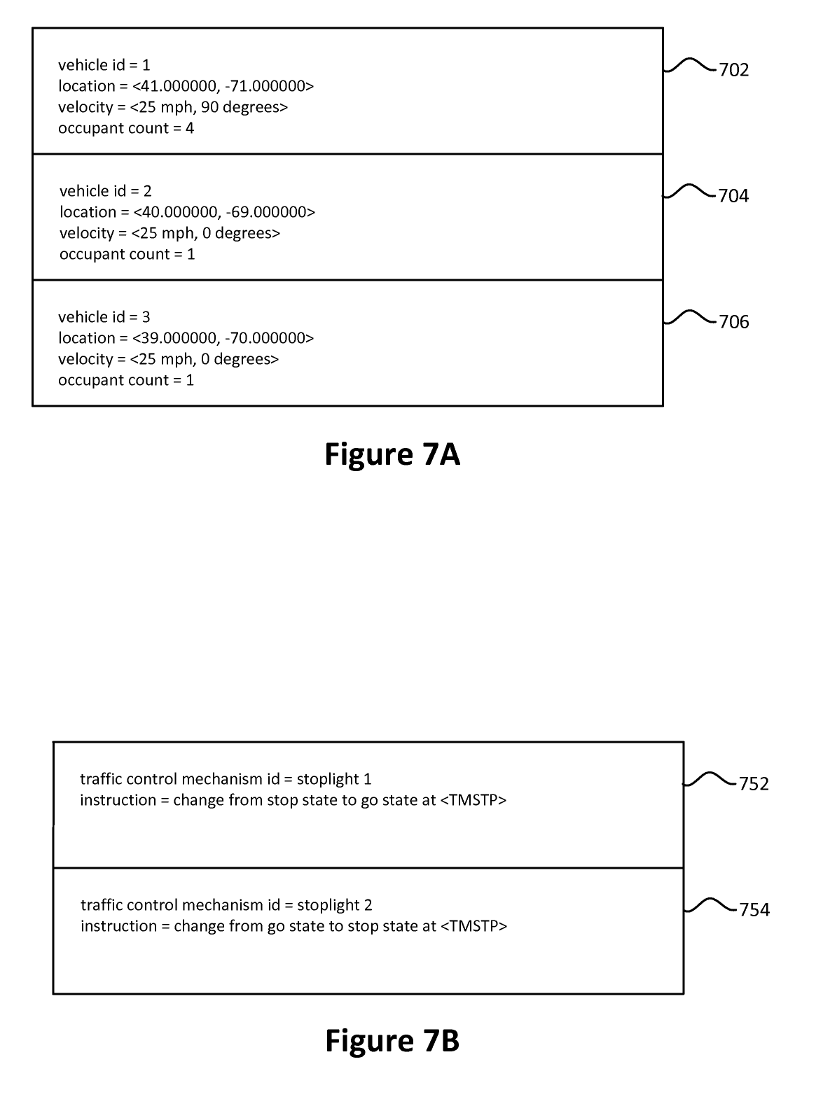

FIG. 7A is a table showing vehicle information according to various embodiments of the disclosure. In the embodiment shown in FIG. 7A, four elements of information are included in the vehicle information: a vehicle identifier, a location of the vehicle, a velocity of the vehicle, and an occupant count. This vehicle information may be transmitted from mobile devices located in the various vehicles to a traffic control server of a traffic control system as previously discussed. Vehicle information 702, 704, and 706 are shown as relating to three different vehicles. The information pertaining to the vehicle identifier, the location of the vehicle, and the velocity of the vehicle may be essentially as described previously in the present disclosure.

The occupant count may be a number representing the number of occupants of the particular vehicle. For example, the occupant count may indicate the total number of persons present in the vehicle at that time. For instance, this may be a value of one for the driver plus the number of passengers. This information may be received in a variety of ways. For example, thus user may manually enter this information using a user interface of the mobile device present in the vehicle. As another example, seat occupancy sensors may be used to determine the number of seats occupied in the vehicle, with that information then being transmitted through a module, such as module 122, to the mobile device present in the vehicle.

The occupant count may not always perfectly specify the number of occupants of the particular vehicle. Instead, the occupant count may be an estimate of the number of occupants of the particular vehicle at that time. For example, if the user does not manually enter an occupant count using a user interface of the mobile device present in the vehicle, a previous value most recently entered by the user may be used. In some instances, an aggregate (average, median, etc.) of previously entered values may be used. In some instances, a value or aggregate of values previously entered at a similar day and time (e.g., “weekday morning” or “weekend morning”) may be used. As is evident from this disclosure, the occupant count need not always be an integer value. Especially where the occupant count is an estimate of the number of occupants of the particular vehicle, a positive rational number that is not necessarily an integer may be appropriate.

As another example for how the occupant count may be determined, a technique based on inter-device communication may be used. For instance, when a vehicle begins traveling, the electronic devices present in the vehicle may attempt to establish a Bluetooth piconet. Based on the establishing of this piconet, the number of electronic devices can be counted and this count provided as part of the vehicle information. This example notwithstanding, electronic devices present in a vehicle may communicate in a variety of ways in order to count the number of such devices as an estimate for the number of occupants in the vehicle.

As another example for how the occupant count may be determined, a technique based on specialized metering hardware may be used. In particular, some vehicles such as public transit buses already have electronic devices for receiving fares indicating the number of passengers boarding the vehicle. A module in communication therewith may estimate the number of occupants of such a vehicle based on information about the number of passengers boarding the vehicle. For instance, such a module may store an accumulation of the total number of passengers boarding the vehicle, and then estimate departures from the vehicle based on historic information about the volume of passenger traffic at various stops along the vehicle's route. In this way, the estimate of occupant count, while not perfectly accurate, reflects both historic departure information and partial current occupancy (i.e., boarding) information. Such a module may then provide this occupant count estimate as part of the vehicle information.

FIG. 7B is a table showing flow control information according to various embodiments of the disclosure. In the embodiment shown in FIG. 7B, two elements of information are included in the flow control information: a traffic control mechanism identifier and an instruction. This flow control information may be substantially the same in form as discussed previously in this disclosure. Flow control information 752 and 754 are shown.

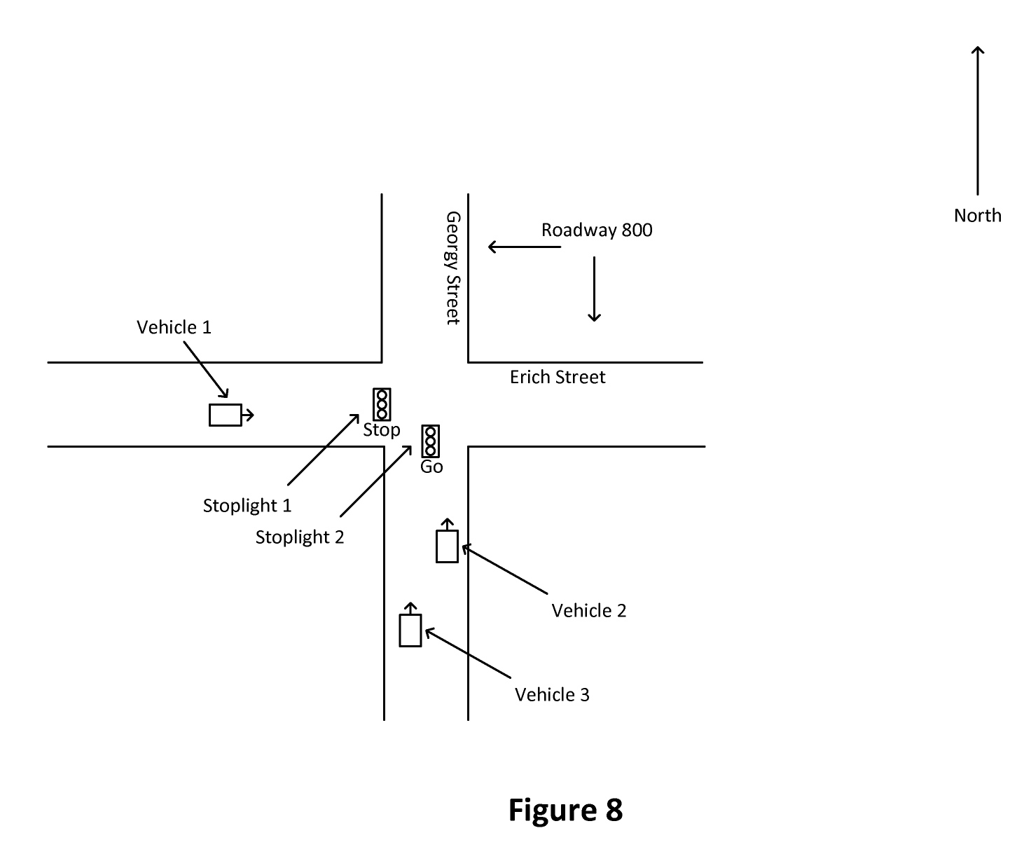

FIG. 8 is a diagram showing the use of vehicle information from FIG. 7A and flow control information from FIG. 7B to improve traffic efficiency according to various embodiments of the disclosure. A roadway 800 containing segments of Erich Street and Georgy Street is shown. An indicator of the North direction is shown, which may correspond with a zero degree heading angle. In the example shown, Erich Street and Georgy Street are both one-way streets, flowing west to east and south to north, respectively. At the intersection of these two streets, Stoplight 1 controls the flow of traffic from the left portion of Erich Street in the eastward direction. Stoplight 2 controls the flow of traffic from the lower portion of Georgy Street in the northward direction.

In the scenario shown in FIG. 8, various vehicles and traffic control mechanisms are active in the transit system. Stoplight 1 is in a stop state. Stoplight 2 is in a go state. These states may be based on some previous vehicles present in the transit system that are not shown here. With reference to FIG. 7A, it can be seen that vehicle 1 is traveling east on Erich Street at 25 MPH. Vehicle 1 has four occupants. Vehicle 2 is traveling north on Georgy Street at 25 MPH. Vehicle 2 has one occupant. Vehicle 3 is traveling north on Georgy Street at 25 MPH. Vehicle 3 has one occupant.

Based on receiving the vehicle information shown in FIG. 7A, a traffic control server or other computing device may process the vehicle information in order to determine or to generate the flow control information shown in FIG. 7B. In particular, when processing the vehicle information, the traffic control server may determine based on the location, velocity, and occupant count information that four persons (vehicle 1) are approaching the intersection of Erich Street and Georgy Street from Erich Street. The traffic control server may determine based on the location, velocity, and occupant count information, however, that only two persons (vehicle 2 and vehicle 3) are approaching the intersection of Erich Street and Georgy Street from Georgy Street. Therefore, a stop state for stoplight 1 produces a total wait time for the transit system of four occupants, while a stop state for stoplight 2 produces a total wait time for the transit system of two occupants. As such, the traffic control server may determine that stoplight 1 and stoplight 2 should change state. Based on this determination, traffic control server may generate the flow control information shown in FIG. 7B. The traffic control server may determine the <TMSTP> as a point in time almost immediately in the future from the current time so that the efficiency improvements of the stoplight state changes can be immediately achieved. The traffic control server may then transmit the flow control information directly to stoplights 1 and 2, or to an intermediate controller device that can execute the instructions. It is worth noting that in this case, based on the occupant count information, a smaller number of vehicles with a larger number of occupants (1 vehicle, 4 occupants) is allowed to proceed, while a larger number of vehicles with a smaller number of occupants (2 vehicles, 2 occupants) is required to wait.

Using the techniques just described, a traffic control system may use location, velocity, and occupant count information received from mobile devices present in various vehicles in order to determine flow control information that will reduce total waiting time for occupants of all vehicles. Though this example was shown with respect to a single intersection, the techniques can be extrapolated to an entire transit system of many intersections, many road segments, many vehicles, many occupants, and many traffic control mechanisms in order to improve the total wait time efficiency for all occupants of all vehicles in the entire transit system.

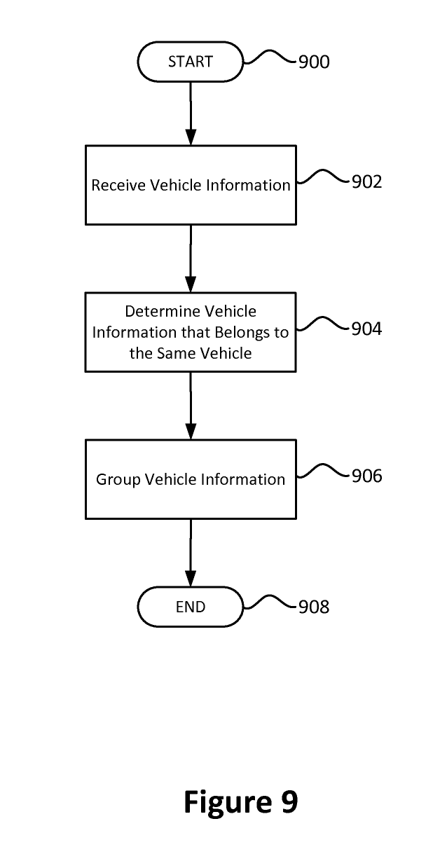

FIG. 9 is a flow chart of a process for determining an occupant count according to various embodiments of the disclosure. In some cases, it may be advantageous or necessary to determine the occupant count for a vehicle at the traffic control server and not with any electronic device present in the vehicle. In such cases, the occupant count information used as described with respect to FIG. 8 may actually be determined based on only vehicle identifier, location, and velocity information as described with respect to FIG. 3A and FIG. 5A. The process of FIG. 9 is an example of how such a determination of the occupant count based on vehicle identifier, location, and velocity can be made. The process begins at block 900.

At block 902, vehicle information is received. In particular, vehicle information may be received from more than one mobile device in the same vehicle. In such a case, the vehicle identifier provided as part of the vehicle information may be a unique identifier of a user instead of a vehicle, as previously described. The vehicle information may be received at a traffic control server.

At block 904, the traffic control server determines that some vehicle information received from different mobile devices actually belongs to the same vehicle. In order to make this determination, the traffic control server may compare the location and velocity information received from various mobile devices. First, the traffic control server may look for numerous elements in the vehicle information that have nearly identical location information. The traffic control server may select the vehicle identifiers for these elements of vehicle information as candidates for grouping. Second, the traffic control server monitors the velocity data received from the candidates for grouping over a period of time. This period of time may be as long as several minutes, for instance. If any of the velocity values received from a particular mobile device diverges from the velocity values received from the other mobile devices, then that mobile device and its corresponding vehicle identifier are determined to no longer be candidates for grouping. After the period of time for monitoring, any mobile devices and their corresponding vehicle identifier still remaining as candidates for grouping are determined to belong to the same vehicle.

At block 906, the candidates for grouping determined to belong to the same vehicle are grouped together and treated from that point forward as a single vehicle in the transit system. An occupant count is associated with the group, where the occupant count is the number of candidates for grouping combined to form the group.

At block 908, the process ends.

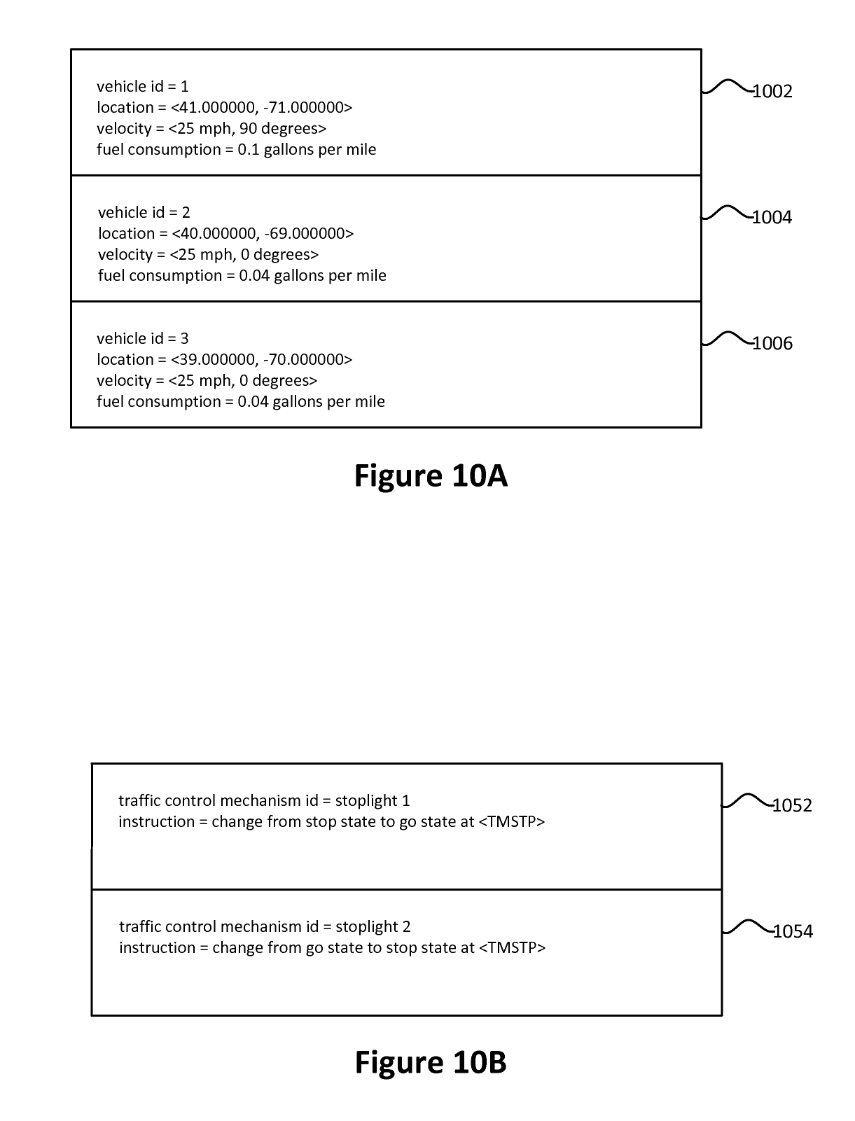

FIG. 10A is a table showing vehicle information according to various embodiments of the disclosure. In the embodiment shown in FIG. 10A, four elements of information are included in the vehicle information: a vehicle identifier, a location of the vehicle, a velocity of the vehicle, and a fuel consumption value. This vehicle information may be transmitted from mobile devices located in the various vehicles to a traffic control server of a traffic control system as previously discussed. Vehicle information 1002, 1004, and 1006 are shown as relating to three different vehicles. The information pertaining to the vehicle identifier, the location of the vehicle, and the velocity of the vehicle may be essentially as described previously in the present disclosure.

The fuel consumption value may be a number representing the rate of fuel consumption of the particular vehicle. For example, an instantaneous fuel consumption value may be provided as part of the vehicle information. Such an instantaneous fuel consumption value be provided by a module present in the vehicle, such as module 122 previously disclosed, that detects the instantaneous fuel consumption of the vehicle and provides that value to the mobile device present in the vehicle for use as part of the vehicle information. As another example, an aggregate (average, median, etc.) of the most recent instantaneous fuel consumption values for the vehicle may be provided. As another example, an aggregate (average, median, etc.) of instantaneous fuel consumption values for situations similar to the present situation may be provided. For instance, a ten-point running average for the most recent instantaneous fuel consumption values for the vehicle based on velocities within 10% of the present velocity may be provided. As another instance, a ten-point running average for the most recent instantaneous fuel consumption values for the vehicle based on locations on the same road segment of the present road segment may be provided. Other forms of fuel consumption information consistent with the present disclosure may be used.

In some embodiments, fuel consumption information received at the traffic control server may be further processed. For instance, if an instantaneous fuel consumption value is received, the traffic control server may perform the aggregation techniques just described above to produce a different fuel consumption value for usage in the processing of the vehicle information to determine flow control information.

FIG. 10B is a table showing flow control information according to various embodiments of the disclosure. In the embodiment shown in FIG. 10B, two elements of information are included in the flow control information: a traffic control mechanism identifier and an instruction. This flow control information may be substantially the same in form as discussed previously in this disclosure. Flow control information 1052 and 1054 are shown.

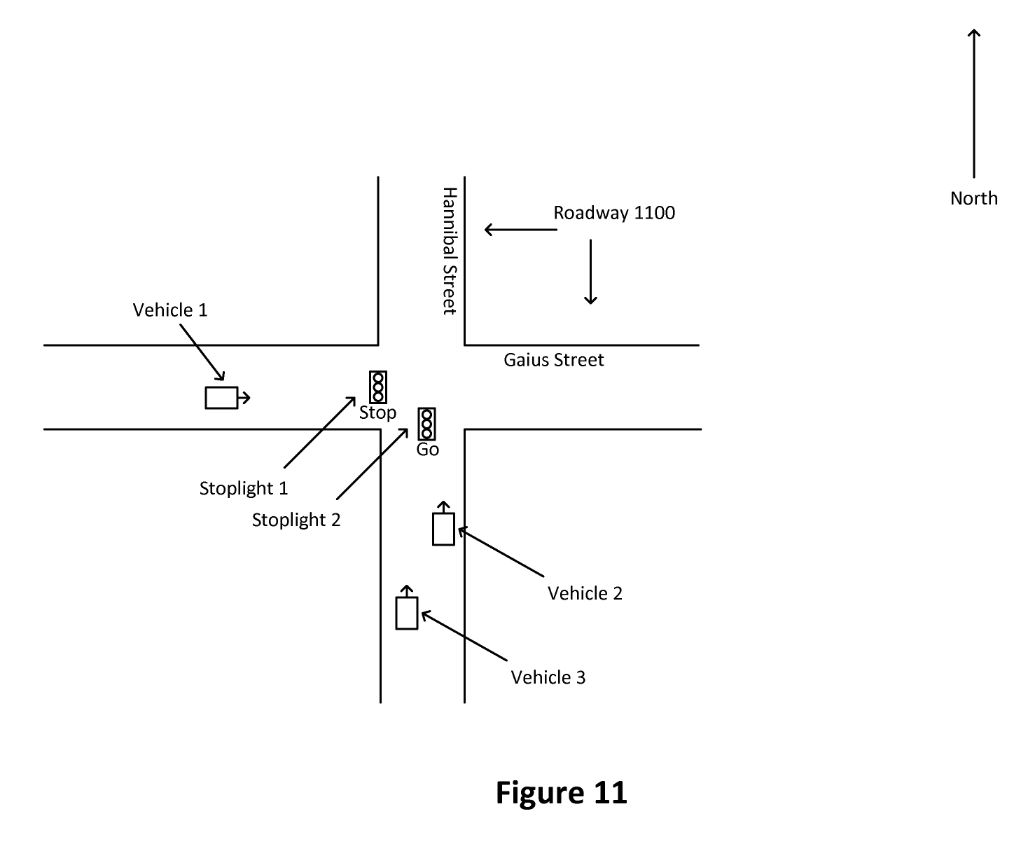

FIG. 11 is a diagram showing the use of vehicle information from FIG. 10A and flow control information from FIG. 10B to improve traffic efficiency according to various embodiments of the disclosure. A roadway 1100 containing segments of Gaius Street and Hannibal Street is shown. An indicator of the North direction is shown, which may correspond with a zero degree heading angle. In the example shown, Gaius Street and Hannibal Street are both one-way streets, flowing west to east and south to north, respectively. At the intersection of these two streets, Stoplight 1 controls the flow of traffic from the left portion of Gaius Street in the eastward direction. Stoplight 2 controls the flow of traffic from the lower portion of Hannibal Street in the northward direction.

In the scenario shown in this diagram, various vehicles and traffic control mechanisms are active in the transit system. Stoplight 1 is in a stop state. Stoplight 2 is in a go state. These states may be based on some previous vehicles present in the transit system that are not shown here. With reference to FIG. 10A, it can be seen that vehicle 1 is traveling east on Gauis Street at 25 MPH. Vehicle 1 is consuming 0.1 gallons per mile. Vehicle 2 is traveling north on Hannibal Street at 25 MPH. Vehicle 2 is consuming 0.04 gallons per mile. Vehicle 3 is traveling north on Hannibal Street at 25 MPH. Vehicle 3 is consuming 0.04 gallons per mile.

Based on receiving the vehicle information shown in FIG. 10A, a traffic control server or other computing device may process the vehicle information in order to determine or to generate the flow control information shown in FIG. 10B. In particular, when processing the vehicle information, the traffic control server may determine based on the location, velocity, and fuel consumption information that one vehicle (vehicle 1) consuming a total of 0.1 gallons of fuel per mile are approaching the intersection of Gauis Street and Hannibal Street from Gauis Street. The traffic control server may determine based on the location, velocity, and fuel consumption information that two vehicles (vehicle 2 and vehicle 3) consuming a total of 0.08 gallons of fuel per mile are approaching the intersection of Gaius Street and Hannibal Street from Hannibal Street. Therefore, a stop state for stoplight 1 produces a total ongoing fuel consumption of 0.1 gallons per mile, while a stop state for stoplight 2 produces a total ongoing fuel consumption of 0.08 gallons per mile. As such, the traffic control server may determine that stoplight 1 and stoplight 2 should change state. Based on this determination, traffic control server may generate the flow control information shown in FIG. 10B. The traffic control server may determine the <TMSTP> as a point in time almost immediately in the future from the current time so that the efficiency improvements of the stoplight state changes can be immediately achieved. The traffic control server may then transmit the flow control information directly to stoplights 1 and 2, or to an intermediate controller device that can execute the instructions. It is worth noting that in this case, based on the fuel consumption information, a smaller number of vehicles with a larger fuel consumption (1 vehicle, 0.1 gallons per mile) is allowed to proceed, while a larger number of vehicles with a smaller fuel consumption (2 vehicles, 0.08 gallons per mile) is required to wait.

Using the techniques just described, a traffic control system may use location, velocity, and fuel consumption information received from mobile devices present in various vehicles in order to determine flow control information that will reduce the total amount of fuel consumption for all vehicles. Though this example was shown with respect to a single intersection, the techniques can be extrapolated to an entire transit system of many intersections, many road segments, many vehicles, and many traffic control mechanisms in order to improve the total fuel consumption for all vehicles in the entire transit system.

In some embodiments, a reverse approach may be used. Namely, the traffic control system may be configured to “penalize” users of fuel inefficient vehicles while “rewarding” users of fuel efficient vehicles. Various techniques may be used for implementing such an approach. For example, vehicles with a fuel consumption value above (less efficient than) a certain threshold value may not be counted in the aggregate fuel consumption calculation for a segment of road. Alternatively, such vehicles may only be counted at that threshold value, thus forming a sort of cap on the inefficiency of fuel consumption that will be counted during processing by the traffic control server. In such cases, a value such as 0.09 gallons per mile or 0.05 gallons per mile may be used. In some embodiments, this threshold value may be scaled based on the type of road segment, such as city versus highway.

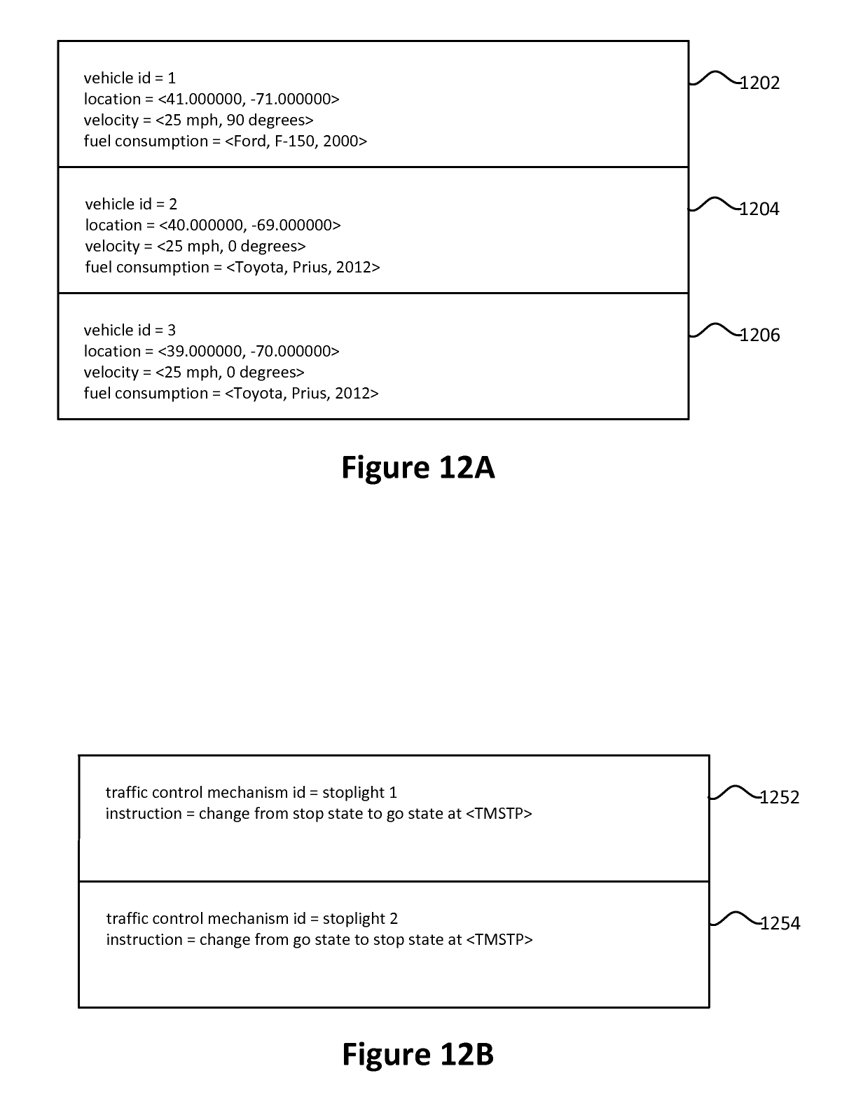

FIG. 12A is a table showing vehicle information according to various embodiments of the disclosure. In the embodiment shown in this figure, four elements of information are included in the vehicle information: a vehicle identifier, a location of the vehicle, a velocity of the vehicle, and fuel consumption information. This vehicle information may be transmitted from mobile devices located in the various vehicles to a traffic control server of a traffic control system as previously discussed. Vehicle information 1202, 1204, and 1206 are shown as relating to three different vehicles. The information pertaining to the vehicle identifier, the location of the vehicle, and the velocity of the vehicle may be essentially as described previously in the present disclosure.

The fuel consumption information may include information about the particular vehicle tending to indicate at what rate the particular vehicle will consume fuel. For example, the make, model, and year of manufacture of the particular vehicle may be provided as the fuel consumption information as part of the vehicle information. While not directly indicating an actual or expected rate of fuel consumption, this information may be used by the traffic control server to retrieve values for the rate of fuel consumption for the vehicle. For instance, the traffic control server may use the make, model, and year of the vehicle to lookup a fuel economy statistics, such as a city value and highway value as published by the U.S. Department of Energy in the Fuel Economy Guide. In such situations, pre-stored information about the road segment over which the vehicle is traveling may additionally be used. For instance, information about the road segment as to the speed limit, traffic congestion, distance between stoplights, etc. may be used to determine the city fuel economy value, the highway economy value, or some value in between that would be most appropriate. Other forms of fuel consumption information consistent with the present disclosure may be used.

FIG. 12B is a table showing flow control information according to various embodiments of the disclosure. In the embodiment shown in this figure, two elements of information are included in the flow control information: a traffic control mechanism identifier and an instruction. This flow control information may be substantially the same in form as discussed previously in this disclosure. Flow control information 1252 and 1254 are shown.

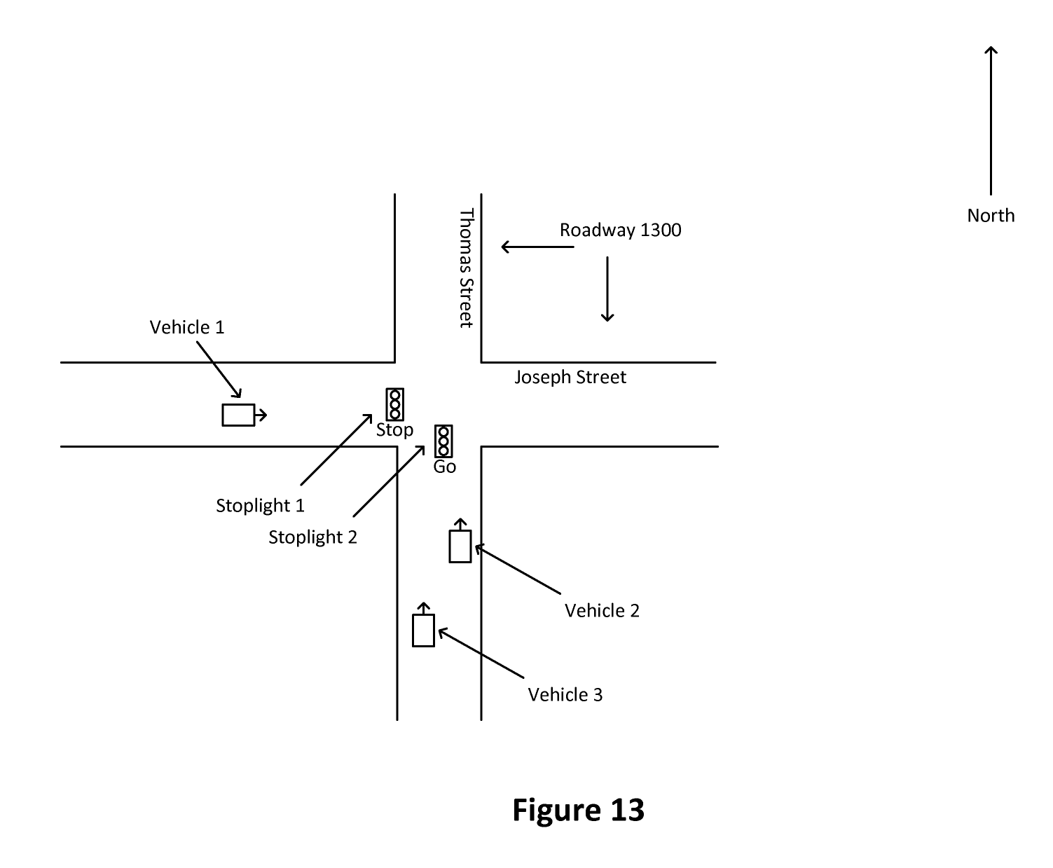

FIG. 13 is a diagram showing the use of vehicle information from FIG. 12A and flow control information from FIG. 12B to improve traffic efficiency according to various embodiments of the disclosure. A roadway 1300 containing segments of Joseph Street and Thomas Street is shown. An indicator of the North direction is shown, which may correspond with a zero degree heading angle. In the example shown, Joseph Street and Thomas Street are both one-way streets, flowing west to east and south to north, respectively. At the intersection of these two streets, stoplight 1 controls the flow of traffic from the left portion of Joseph Street in the eastward direction. Stoplight 2 controls the flow of traffic from the lower portion of Thomas Street in the northward direction.

In the scenario shown in FIG. 13, various vehicles and traffic control mechanisms are active in the transit system. Stoplight 1 is in a stop state. Stoplight 2 is in a go state. These states may be based on some previous vehicles present in the transit system that are not shown here. With reference to FIG. 12A, it can be seen that vehicle 1 is traveling east on Joseph Street at 25 MPH. Vehicle 1 is a 2000 Ford F-150. The traffic control server may retrieve city fuel economy data for vehicle 1 and thus assign a value of 0.0625 gallons per mile as the expected rate of fuel consumption for the vehicle. Vehicle 2 is traveling north on Thomas Street at 25 MPH. The traffic control server may retrieve city fuel economy data for vehicle 2 and thus assign a value of 0.0196 gallons per mile as the expected rate of fuel consumption for the vehicle. Vehicle 3 is traveling north on Thomas Street at 25 MPH. The traffic control server may retrieve city fuel economy data for vehicle 3 and thus assign a value of 0.0196 gallons per mile as the expected rate of fuel consumption for the vehicle.

Based on receiving the vehicle information shown in FIG. 12A, a traffic control server or other computing device may process the vehicle information in order to determine or to generate the flow control information shown in FIG. 12B. In particular, when processing the vehicle information, the traffic control server may determine based on the location, velocity, and fuel consumption information that one vehicle (vehicle 1) consuming a total of 0.0625 gallons of fuel per mile is approaching the intersection of Joseph Street and Thomas Street from Joseph Street. The traffic control server may determine based on the location, velocity, and fuel consumption information that two vehicles (vehicle 2 and vehicle 3) consuming a total of 0.0392 gallons of fuel per mile are approaching the intersection of Joseph Street and Thomas Street from Thomas Street. Therefore, a stop state for stoplight 1 produces a total ongoing fuel consumption of 0.0625 gallons per mile, while a stop state for stoplight 2 produces a total ongoing fuel consumption of 0.0392 gallons per mile. As such, the traffic control server may determine that stoplight 1 and stoplight 2 should change state. Based on this determination, traffic control server may generate the flow control information shown in FIG. 12B. The traffic control server may determine the <TMSTP> as a point in time almost immediately in the future from the current time so that the efficiency improvements of the stoplight state changes can be immediately achieved. The traffic control server may then transmit the flow control information directly to stoplights 1 and 2, or to an intermediate controller device that can execute the instructions. It is worth noting that in this case, based on the fuel consumption information, a smaller number of vehicles with a larger fuel consumption (1 vehicle, 0.0625 gallons per mile) is allowed to proceed, while a larger number of vehicles with a smaller fuel consumption (2 vehicles, 0.0392 gallons per mile) is required to wait.

Using the techniques just described, a traffic control system may use location, velocity, and fuel consumption information received from mobile devices present in various vehicles in order to determine flow control information that will reduce the total amount of fuel consumption for all vehicles. Though this example was shown with respect to a single intersection, the techniques can be extrapolated to an entire transit system of many intersections, many road segments, many vehicles, and many traffic control mechanisms in order to improve the total fuel consumption for all vehicles in the entire transit system.

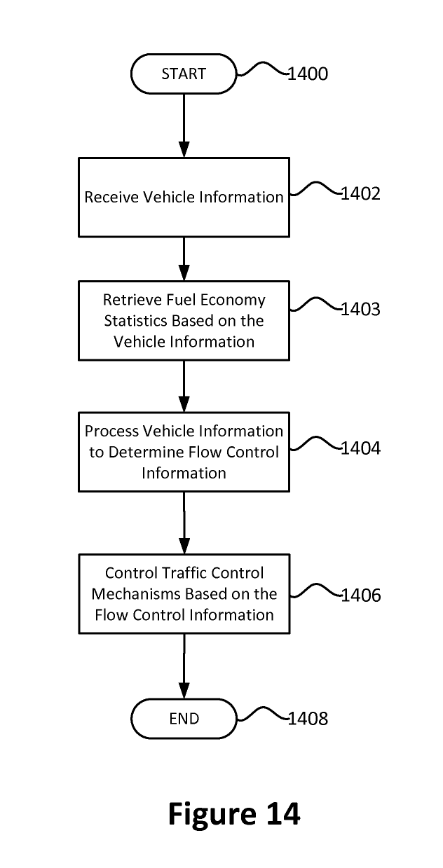

FIG. 14 is a flow chart of a process for traffic efficiency according to various embodiments of the disclosure. Blocks 1400, 1402, 1404, 1406, and 1408 may be performed in substantially the same way as described for blocks 200, 202, 204, 206, and 208, respectively, of FIG. 2. However, the process of FIG. 14 contains an additional block 1403. At block 1403, fuel economy statistics are retrieved based on the vehicle information received at block 1402. As described previously, the vehicle information may include information about a particular vehicle that can be used to retrieve expected fuel consumption information. As an example, the traffic control server may retrieve Fuel Economy Guide statistics for the rate of fuel consumption based on the identification of the make, model, and year of the vehicle in the vehicle information. These or other fuel economy statistics may be stored on an electronic storage device that is accessible to the traffic control server. Based on the fuel economy statistics retrieved in block 1403, the vehicle information, now including an expected fuel consumption value, may be processed to determine flow control information in block 1404. Traffic control mechanisms may then be controlled based on that flow control information at block 1406. The process ends at block 1408.

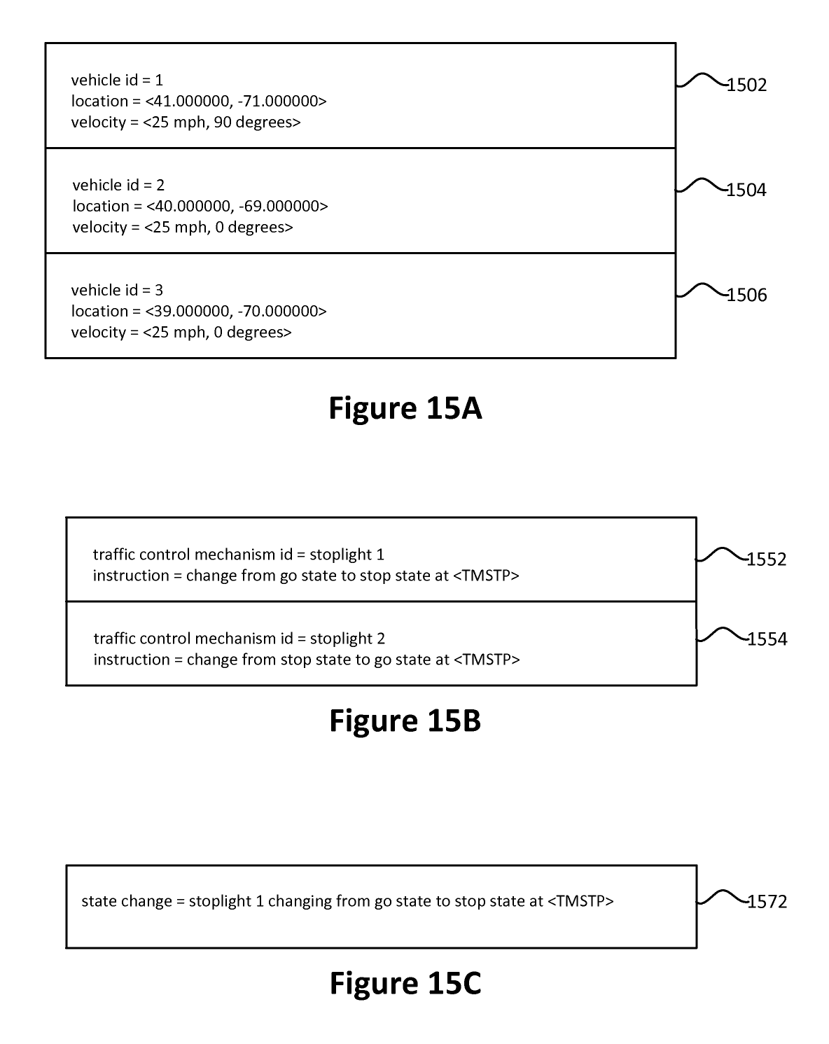

FIG. 15A is a table showing vehicle information according to various embodiments of the disclosure. In the embodiment shown in FIG. 15A, three elements of information are included in the vehicle information: a vehicle identifier, a location of the vehicle, and a velocity of the vehicle. This vehicle information may be transmitted from mobile devices located in the various vehicles to a traffic control server of a traffic control system as previously discussed. Vehicle information 1502, 1504, and 1506 are shown as relating to three different vehicles. The information pertaining to the vehicle identifier, the location of the vehicle, and the velocity of the vehicle may be essentially as described previously in the present disclosure.

FIG. 15B is a table showing flow control information according to various embodiments of the disclosure. In the embodiment shown in FIG. 15B, two elements of information are included in the flow control information: a traffic control mechanism identifier and an instruction. This flow control information may be substantially the same in form as discussed previously in this disclosure. Flow control information 1552 and 1554 are shown.

FIG. 15C is a table showing state change information according to various embodiments of the disclosure. In the embodiment shown in FIG. 15C, the state change information includes information describing the change of a state of a traffic control mechanism. State change information 1572 is shown.

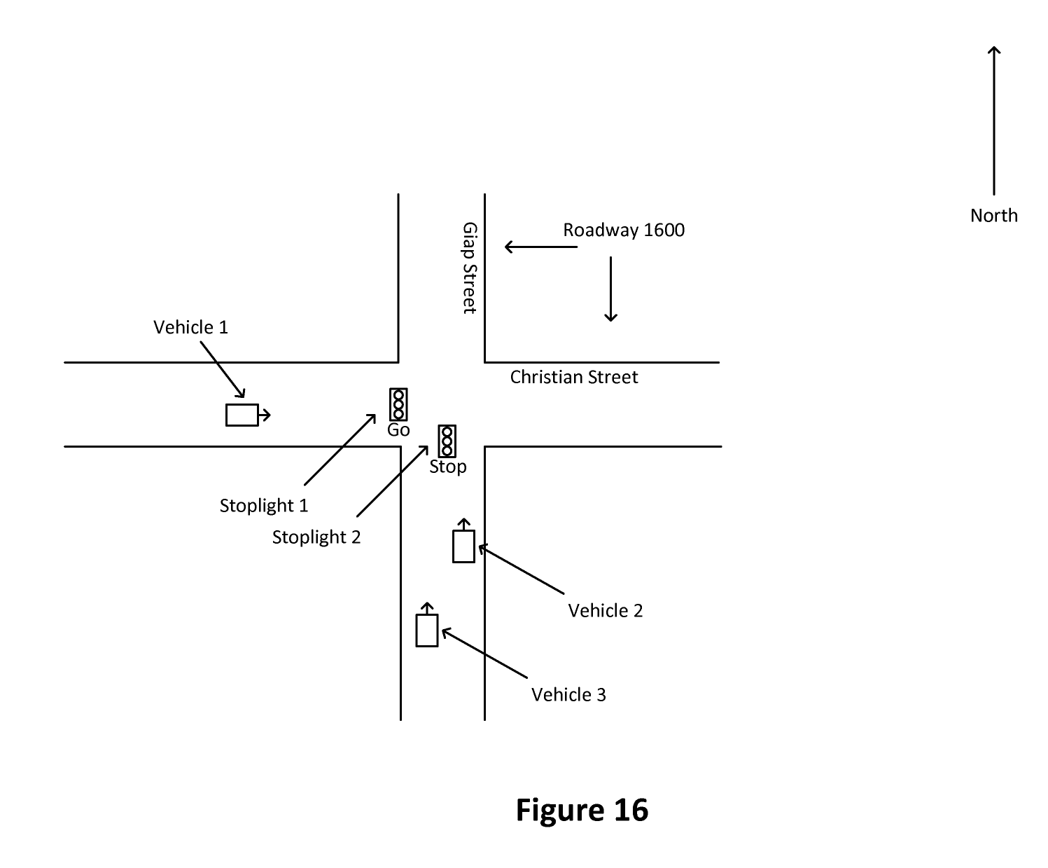

FIG. 16 is a diagram showing the use of vehicle information from FIG. 15A and flow control information from FIG. 15B to improve traffic efficiency according to various embodiments of the disclosure. A roadway 1600 containing segments of Christian Street and Giap Street is shown. An indicator of the North direction is shown, which may correspond with a zero degree heading angle. In the example shown, Christian Street and Giap Street are both one-way streets, flowing west to east and south to north, respectively. At the intersection of these two streets, stoplight 1 controls the flow of traffic from the left portion of Christian Street in the eastward direction. Stoplight 2 controls the flow of traffic from the lower portion of Giap Street in the northward direction.

In the scenario shown in FIG. 16, various vehicles and traffic control mechanisms are active in the transit system. Stoplight 1 is in a go state. Stoplight 2 is in a stop state. These states may be based on some previous vehicles present in the transit system that are not shown here. With reference to FIG. 15A, it can be seen that vehicle 1 is traveling east on Christian Street at 25 MPH. Vehicle 2 is traveling north on Giap Street at 25 MPH. Vehicle 3 is traveling north on Giap Street at 25 MPH.

Based on receiving the vehicle information shown in FIG. 15A, a traffic control server or other computing device may process the vehicle information in order to determine or to generate the flow control information shown in FIG. 15B. In particular, when processing the vehicle information, the traffic control server may determine based on the location and velocity information that one vehicle (vehicle 1) is approaching the intersection of Christian Street and Giap Street from Christian Street. The traffic control server may determine based on the location and velocity information that two vehicles (vehicle 2 and vehicle 3) are approaching the intersection of Christian Street and Giap Street from Giap Street. The traffic control server may determine that the states of stoplights 1 and 2 should change, such as by using the total wait time processing as previously described in the present disclosure. Based on this determination, traffic control server may generate the flow control information shown in FIG. 15B. The traffic control server may determine the <TMSTP> as a point in time almost immediately in the future from the current time so that the efficiency improvements of the stoplight state changes can be immediately achieved. The traffic control server may then transmit the flow control information directly to stoplights 1 and 2, or to an intermediate controller device that can execute the instructions.

In some embodiments, the traffic control server may additionally transmit state change information for one or more traffic control mechanisms to one or more vehicles. The state change information may be transmitted by way of the same communications network and mobile device from which the vehicle information was received. Alternatively, some other transmission technology may be used. As an example with respect to the present diagram, the traffic control server may transmit the state change information shown in FIG. 15C to vehicle 1. The state change information informs vehicle 1 that stoplight will be changing from the present go state to the stop state at <TMSTP>.

In some embodiments, the state change information for one or more traffic control mechanisms received at a vehicle may be used in the operation of that vehicle. For example with reference to FIG. 16, when vehicle 1 receives state change information advising that stoplight 1 will be changing from a go state to a stop state at <TMSTP>, a module present in vehicle 1, such as module 122 previously described, may provide an audible alert to the driver of vehicle 1. For example, the audible alert may be computer generated speech that states “Approaching a red light. Please slow down.” The audible alert may be generated based on the state change being received at the mobile device present in the vehicle, whereupon it is transmitted to the module present in the vehicle. In some embodiments, the mobile device may be used to deliver this audible alert. As another example, the mobile device or another device present in the vehicle, such as module 122, may be configured to process the received state change information in conjunction with position information and velocity information to determine an alert to deliver. For instance, upon receiving the state change information pertaining to stoplight 1 at vehicle 1, the mobile device may compare <TMSTP> to the current position and current velocity of vehicle 1 and a known position of stoplight 1 in order to determine if vehicle 1 will safely pass through the intersection before the state change occurs. If the mobile device determines that vehicle 1 will not do so, it may deliver a more urgent audible alert, such as “Don't even try to make that light. Hit the brakes!” In some embodiments, determinations and calculations as just described as occurring at the mobile device or other module present in the vehicle may instead be performed at the traffic control server. Results of these determinations, such as a determination that vehicle 1 will not make it through the intersection before the red light, may be used to control different type of state change information to transmit to the vehicle.

As another example of using the state change information in the operation of a vehicle, the acceleration or other operation of the vehicle may be controlled based on the state change information. In some vehicles, a module present in the vehicle, such as module 122 previously described, may be able to automatically control mechanical functions of the vehicle. For instance, the module may be able to increase or decrease acceleration of the vehicle by controlling a throttle or other mechanism automatically, i.e., without input from the driver. As another instance, the module may be able to engage the brakes of the vehicle automatically. In such cases, the module may automatically control the acceleration of the vehicle using automatic control of the throttle, brakes, or other mechanism based on the state change information. For the present diagram, the module may determine that vehicle 1 will not be able to pass through the intersection before the state change of stoplight 1. As such, the module may reduce the application of the throttle. The module may at the same time or later as the vehicle more closely approaches the stoplight activate the brakes. In this way, the module may prevent unnecessary acceleration of the vehicle based on the state change information. Here the acceleration is described as unnecessary because the vehicle would be accelerating towards the intersection even though it would eventually need to fully decelerate to a stationary position based on the imminent stop state of the stoplight. This approach may be beneficial to reduce fuel consumption, to reduce wear and tear on the vehicle, and to increase the safety of operation of the vehicle.

Using the techniques just described, a traffic control system may use location and velocity information received from mobile devices present in various vehicles in order to determine flow control information that will improve some form of traffic efficiency in the transit system. Using these techniques, the traffic control system is then able to allow improvements in efficiency, wear and tear, and safety in the operation of one or more vehicles in the transit system by providing those one or more vehicles with information about the change of state of traffic control mechanisms. Though this example was shown with respect to a single intersection, the techniques can be extrapolated to an entire transit system of many intersections, many road segments, many vehicles, and many traffic control mechanisms in order to improve various forms of efficiency for all vehicles in the entire transit system.

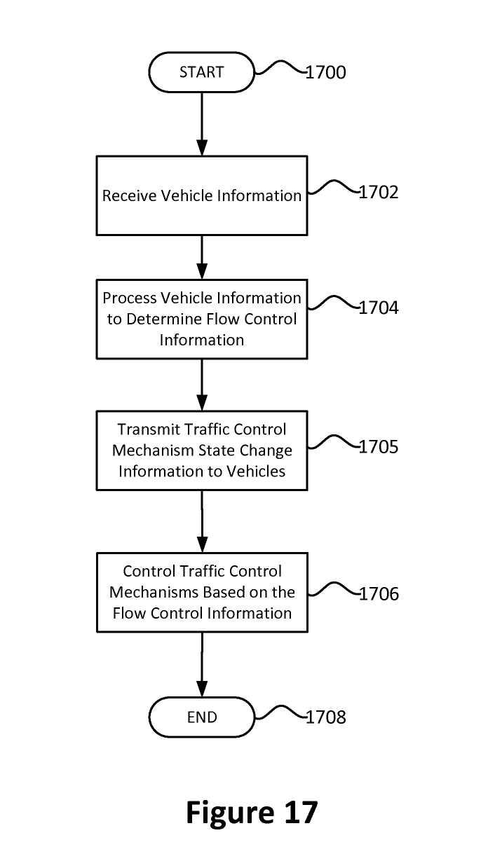

FIG. 17 is a flow chart of a process for traffic efficiency according to various embodiments of the disclosure. Blocks 1700, 1702, 1704, 1706, and 1708 may be performed in substantially the same way as described for blocks 200, 202, 204, 206, and 208, respectively, of FIG. 2. However, the process of FIG. 17 contains an additional block 1705. At block 1705, state change information about one or more traffic control mechanisms is transmitted to one or more vehicles in the transit system. This state change information may reflect the determined flow control information. This state change information may be provided in a variety of forms, such as those previously described in this disclosure. The vehicle receiving the state change information, such as via a mobile device present in the vehicle, may then use that state change information in a variety of ways. The traffic control mechanisms are controlled based on the flow control information in block 1706. The process ends at block 1708.

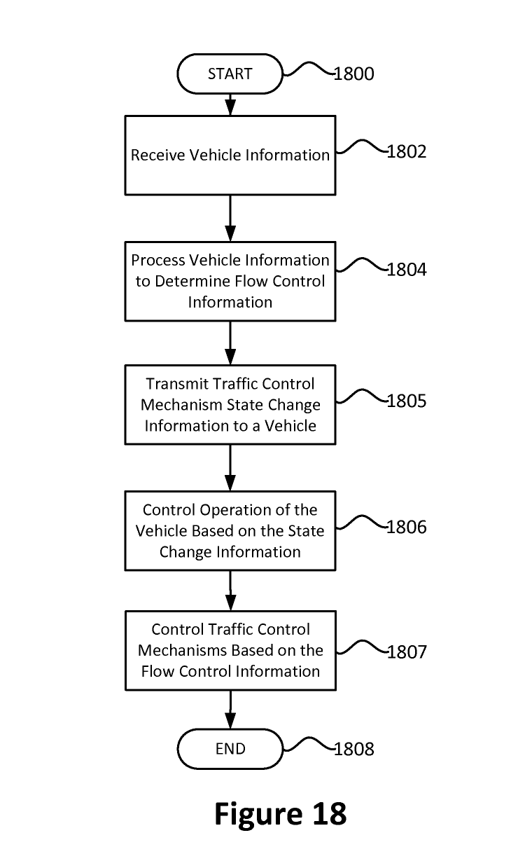

FIG. 18 is a flow chart of a process for traffic efficiency according to various embodiments of the disclosure. Blocks 1800, 1802, 1804, 1805, 1807, and 1808 may be performed in substantially the same way as described for blocks 1700, 1702, 1704, 1705, 1706, and 1708, respectively, of FIG. 17. However, the process of FIG. 18 contains an additional block 1806. At block 1806, for a vehicle that receives the state change information, operation of the vehicle is controlled based on the state change information. This control of the operation of the vehicle may be performed in a variety of ways. For example, automatic throttle control or brake control may be performed based on the state change information as previously described in the present disclosure. The traffic control mechanisms are controlled based on the flow control information in block 1807. The process ends at block 1808.

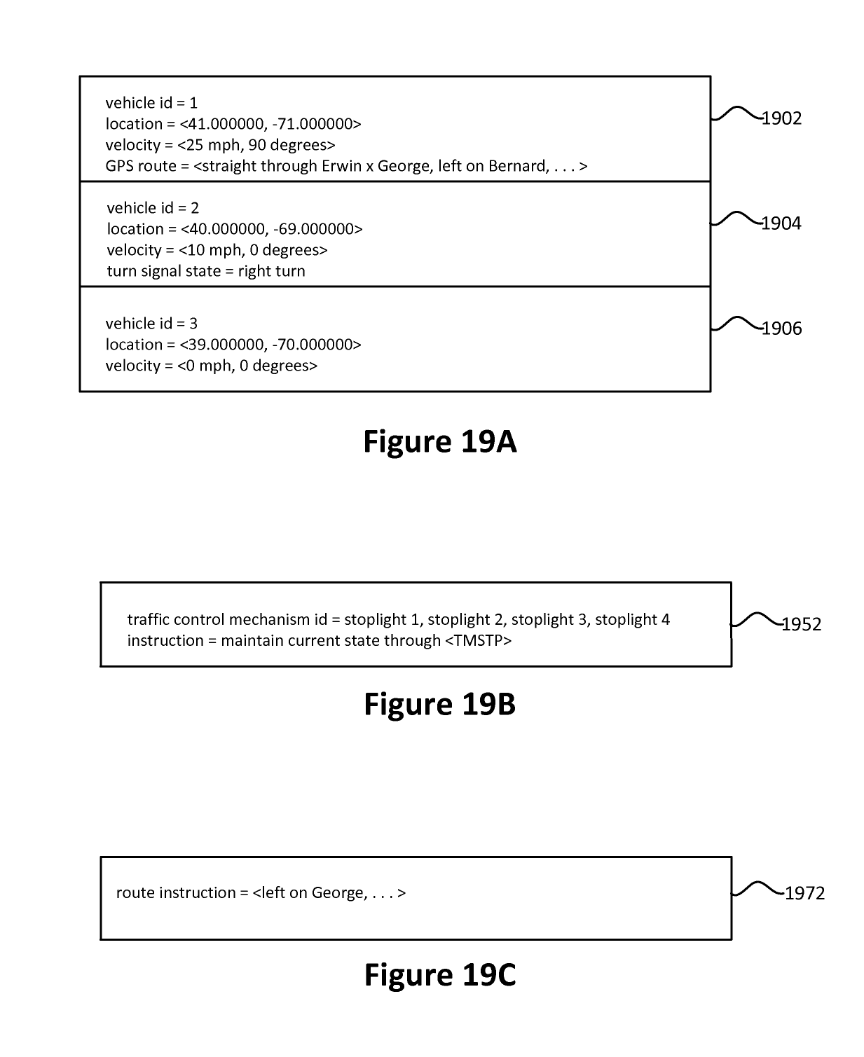

FIG. 19A is a table showing vehicle information according to various embodiments of the disclosure. In the embodiment shown in FIG. 19A, various elements of information are included in the vehicle information: a vehicle identifier, a location of the vehicle, a velocity of the vehicle, and future location information. This vehicle information may be transmitted from mobile devices located in the various vehicles to a traffic control server of a traffic control system as previously discussed. Vehicle information 1902, 1904, and 1906 are shown as relating to three different vehicles. The information pertaining to the vehicle identifier, the location of the vehicle, and the velocity of the vehicle may be essentially as described previously in the present disclosure. The future location information is shown in the form of GPS route information for vehicle 1 and turn signal state information for vehicle 2.

Future location information may be information tending to indicate where a particular vehicle will be in the future. In some embodiments, this may be information beyond the position information and location information for the vehicle. For example, information defining a route in a GPS device present in the vehicle may be future location information. If the driver of the vehicle is following a route displayed on the GPS device, then information about the route (the turns anticipated) tends to indicate where the vehicle will travel in the future. As another example, turn signal state information for turn signals installed in the vehicle may be future location information. The current state of the turn signal (left turn, right turn, not active) in a vehicle may tend to indicate how the vehicle will proceed through an intersection that the vehicle is approaching. Other forms of future location information consistent with the present disclosure may be used.

FIG. 19B is a table showing flow control information according to various embodiments of the disclosure. In the embodiment shown in this figure, two elements of information are included in the flow control information: a traffic control mechanism identifier and an instruction. This flow control information may be substantially the same in form as discussed previously in this disclosure. Flow control information 1952 is shown.

FIG. 19C is a table showing route instruction information according to various embodiments of the disclosure. In the embodiment shown in this figure, the route instruction information includes information describing a route that a vehicle should follow. Route instruction information 1972 is shown.

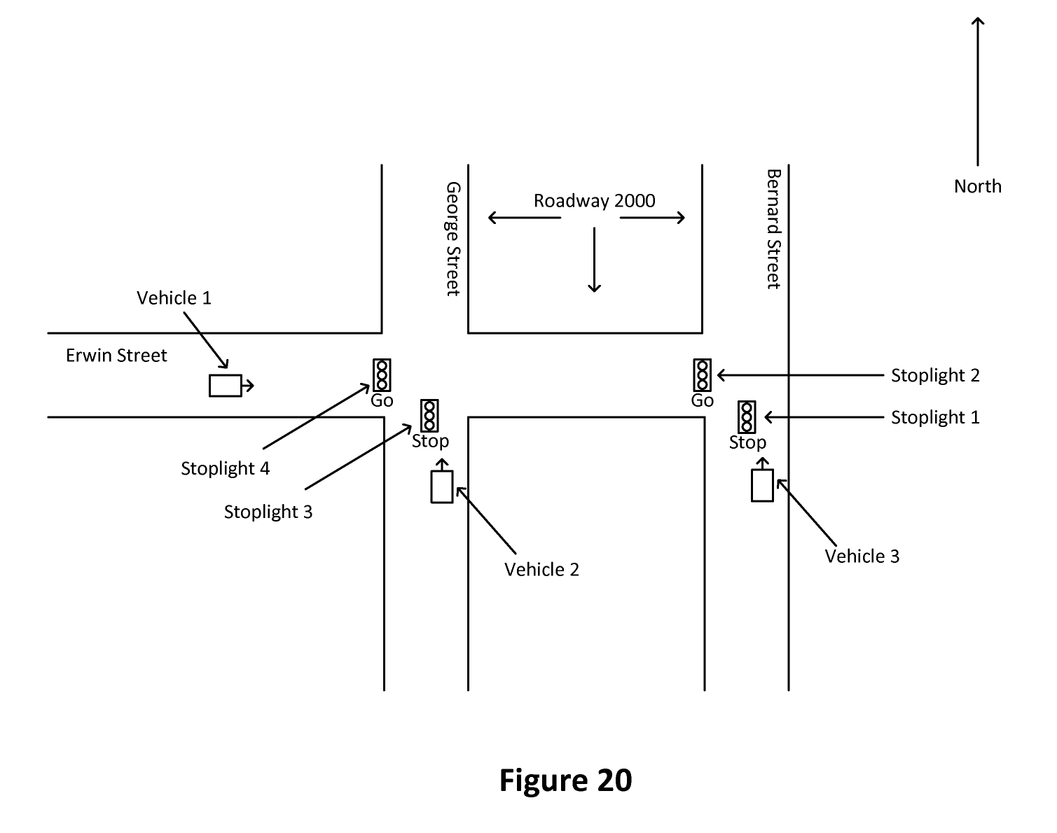

FIG. 20 is a diagram showing the use of vehicle information from FIG. 19A and flow control information from FIG. 19B to improve traffic efficiency according to various embodiments of the disclosure. A roadway 2000 containing segments of Erwin Street, George Street, and Bernard Street is shown. An indicator of the North direction is shown, which may correspond with a zero degree heading angle. In the example shown, Erwin Street, George Street, and Bernard Street are one-way streets, flowing west to east, south to north, and south to north, respectively. Stoplights 1, 2, 3, and 4 control the flow of traffic into the intersections of these streets.

In the scenario shown in FIG. 20, various vehicles and traffic control mechanisms are active in the transit system. Stoplight 1 is in a stop state. Stoplight 2 is in a go state. Stoplight 3 is in a stop state. Stoplight 4 is in a go state. These states may be based on some previous vehicles present in the transit system that are not shown here. With reference to FIG. 19A, it can be seen that vehicle 1 is traveling east on Erwin Street at 25 MPH. Vehicle 2 is traveling north on George Street at 10 MPH. Vehicle 3 is traveling north on Bernard Street at 0 MPH. The future location information for vehicle 1 indicates that vehicle 1 is likely to proceed straight through the intersection of Erwin Street and George Street, and then turn left on Bernard Street. Additional details of the route may be included but are not shown in the figure. The future location information for vehicle 2 indicates that vehicle 2 is likely to make a right turn on Erwin Street based on the right turn signal being active.

Based on receiving the vehicle information shown in FIG. 19A, a traffic control server or other computing device may process the vehicle information in order to determine or to generate the flow control information shown in FIG. 19B. In particular, the traffic control server might generally tend to produce flow control information indicating that stoplight 1 should change to a go state and thus stoplight 2 should change to a stop state. This might be the result if the traffic control server were seeking to minimize total wait time. In the present diagram, vehicle 3 is waiting at stoplight 1, but no vehicles are presently waiting at or sure to approach stoplight 2. However, given the future location information, the traffic control server can determine that both vehicle 1 and vehicle 2 are likely to approach stoplight 2 as they leave the intersection of Erwin Street and George Street. As such, the traffic control server may generate flow control information 1952 that indicates that all stoplights should maintain their current states until <TMSTP>, when vehicles 1 and 2 will likely have passed through the intersection of Erwin Street and Bernard Street. The traffic control server may then transmit the flow control information directly to stoplights 1 and 2, or to an intermediate controller device that can execute the instructions.

Using the techniques just described, a traffic control system may use location information, velocity information, and future location information received from mobile devices present in various vehicles in order to determine flow control information that will improve some form of traffic efficiency in the transit system. Using the future location information, the traffic control system may be able to improve the traffic efficiency to an even greater level than some other techniques described in the present disclosure that do not have such information available. Though this example was shown with respect to two intersections, the techniques can be extrapolated to an entire transit system of many intersections, many road segments, many vehicles, and many traffic control mechanisms in order to improve various forms of efficiency for all vehicles in the entire transit system.

In some embodiments, future location information may be determined by the traffic control server as opposed to being provided by the vehicle. The traffic control server or some associated device may store information as to historic traffic patterns (such as tracks or paths travelled) for a vehicle. Then, when the vehicle begins travelling in some instance, the traffic control server can retrieve the information as to historic traffic patterns for the vehicle and process that information to estimate where the vehicle is likely to travel. In this way, the traffic control server may determine future location information based on processing of information as to historic traffic patterns for a vehicle. For example, a vehicle may historically follow more or less the same route every morning during a morning commute from home to work. This information may be stored as traffic pattern information. When a vehicle begins travelling on some morning, the traffic control server may retrieve the historic traffic patterns and process them to determine that the vehicle is likely travelling that frequented path from home to work. This future location information can then be used as part of the vehicle information to be processed so as to determine flow control information as described elsewhere in the present disclosure. In some instances, the traffic control server may attempt to match the vehicle's present travel to a subset of the stored historic traffic pattern information during the processing of that information. For instance, the traffic control server may attempt to find historic traffic pattern information with a similar travel start time (0700 hours) and similar travel start location (“home”) as the present travel start time and present travel start location.

In some embodiments, the traffic control system may provide route instruction information to one or more vehicles in the transit system. The route instruction information may be used to instruct the vehicle or a user of the vehicle to follow a particular route specified by the route instruction information. Such as exemplary situation can be described with respect to FIG. 19A and FIG. 20, but with different flow control information than that shown in FIG. 19B. In this exemplary situation, vehicle 1 provides future location information to the transit control system indicating that vehicle 1 is following a route straight through the intersection of Erwin Street and George Street, then left on Bernard Street, and then take some subsequent actions not shown. If, based on various other vehicle information received by the transit control system, flow control information is generated that will result in a change of stoplight 2 to a stop state before vehicle 1 arrives at the intersection, then the transit control system can transmit route instruction information 1972 to vehicle 1. Route instruction information 1972 instructs vehicle 1 to turn left on George Street (instead of proceeding straight) and then take some subsequent actions not shown. In this way, vehicle 1 may be instructed so as to arrive at the same destination location, but via a route that is likely to be more efficient, such as by having less wait time. In other instances, the route instruction information may be provided to balance traffic flow across multiple parallel roads, to reduce anticipated or present congestion at an intersection, or for other traffic efficiency purposes. Where such route instruction information is transmitted to a vehicle, it may be received by the mobile device present therein. The route instruction information may then be communicated to a GPS device present in the vehicle and displayed as a change of route to the driver of the vehicle. Alternatively, the vehicle may automatically change its course based on the route instruction information where the vehicle is capable of partial or fully autonomous navigation.

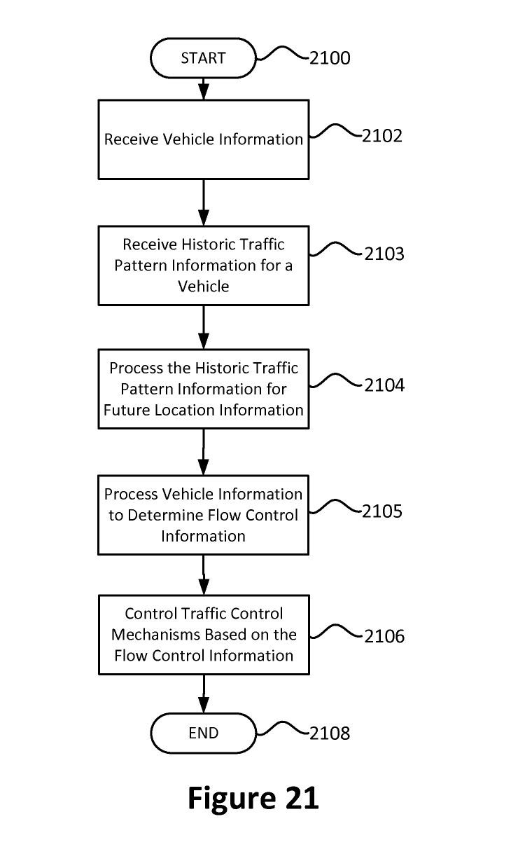

FIG. 21 is a flow chart of a process for traffic efficiency according to various embodiments of the disclosure. Blocks 2100, 2102, 2105, 2106, and 2108 may be performed in substantially the same way as described for blocks 200, 202, 204, 206, and 208, respectively, of FIG. 2. However, the process of this figure contains additional blocks 2103 and 2104. At block 2103, historic traffic pattern information is retrieved for a particular vehicle. This may be performed as previously described in the present disclosure. At block 2104, the historic traffic pattern information is processed in order to determine future location information for the particular vehicle. This may be performed as previously described in the present disclosure. The vehicle information, including the future location information, is processed in order to determine flow control information in block 2105. The traffic control mechanisms are controlled based on the flow control information in block 2106. The process ends at block 2108.

In some embodiments, the techniques described in the present disclosure may be used to more efficiently control a left turn signal of a stoplight. In particular, a left turn signal of a stoplight in conventional transit systems is often triggered by an inductance sensor in the road bed, and then the left turn signal is held in a go state for a predefined fixed period of time. This predefined fixed period of time may depend on the time of day or day of week, but conventional system do not have a way to use a variable period of time defined in real-time for the go state. With the traffic control system described herein, the traffic control system may be able to determine how many cars are waiting at a left turn signal in order to make a left turn. This determination may be made based on the processing blocks described herein and based on various elements of vehicle information: velocity, location, turn signal state, GPS route, etc. Based on a determination of x cars waiting at the left turn signal in order to make a left turn, the traffic control system may generate flow control information that specifies the left turn signal to switch to a go state at <TMSTP 1> and switch back to a stop state at <TMSTP 2>, where the length of time <TMSTP 1>-<TMSTP 2> is an expected amount of time required for x vehicles to make the left turn.

In some embodiments, the techniques described in the present disclosure may be used to more efficiently move clusters of vehicles through the transit system. In particular, while some conventional systems provide sequences of stoplights on a road segment that are synchronized to allow periods of continuous flow through the sequence of stoplights (and associated intersections), this stoplight synchronization may not be optimized for actual clusters of vehicles traveling in the transit system. In particular, such synchronization techniques require a predetermined estimation of how long a vehicle will take to pass from one intersection to another. The sequential stoplights may then be synchronized to allow such a vehicle to pass continuously along the roadway with all stoplights in a go state. However, heavy traffic, blocked lanes, and other factors may prevent the actual vehicles from travelling at the predicted rate. As such, all or some of the vehicles may have to stop at one of the stoplights due to not meeting the expected rate of travel. With the traffic control system described herein, sequential stoplights may be held in a go state to allow for groups of vehicles to pass through without stopping, where the go state of each stoplight is held as the traffic control system monitors a group of vehicles passing through each intersection. In a more general statement of this technique, a particular stoplight may be changed to a go state immediately before the head of a large clump of vehicles reaches the intersection, while the particular stoplight may be changed to a stop state immediately after the tail of the large clump of vehicles passes through the intersection. In this way, an increased throughput can be achieved when a stoplight is changed to a go state.

In various embodiments, a mobile device present in a vehicle may begin transmitting vehicle information based on one or more indicators of present travel. For example, a user may indicate that travel is beginning and thus vehicle information transmission should begin. The user may make this indication using a user interface of the mobile device, such as by interacting with a software application installed on the mobile device. As another example, the mobile device may determine that travel has begun based on a sustained change in location. By monitoring the location information, such as provided by a GPS module on the mobile device, the mobile device may determine that the mobile device is in a vehicle in transit if the location changes frequently and with a speed associated with a moving vehicle. As another example, a module installed in the vehicle may be configured to detect some activation of the vehicle, such as turning of the ignition or powering up of the electrical systems. When such activation is detected, the module may transmit an indication of present travel to the mobile device present in the vehicle. This transmission may be performed using a variety of communication technologies, such as that described for communication between module 122 and mobile device 132. Other techniques for determining when vehicle information transmission should begin may be used consistent with the present disclosure.

In some embodiments, a combination of the various traffic efficiency techniques described herein may be used. For example, the traffic control system may be configured to consider both occupant wait time and fuel consumption when processing the vehicle information in order to determine flow control information. As an example, a technique may be used where any potential element of flow control information (such as a particular state change for a particular stoplight) receives an aggregate goodness score. This goodness score may be calculated by determining a goodness of the flow control information under occupant wait time efficiency and a separate goodness of the flow control information under fuel consumption efficiency. These two goodness scores can then be combined into the aggregate goodness score. These efficiency approaches may be given different levels of importance, such as by weighting the occupant wait time efficiency goodness score by ¾ and weighting the fuel consumption efficiency goodness score by ¼ prior to combining Using this or similar approaches consistent with the present disclosure, a flexible determination of flow control information can be made based on various types of traffic efficiency.

In various embodiments, information about aspects of the transit system may be stored in the traffic control system prior to or asynchronous to real-time operation. For instance, information defining the roadway, the road segments, the intersections, the lanes on the road segments, turn restrictions on the lanes, etc. may be stored in advance in order to allow or improve the techniques described in the present disclosure. Other information may be periodically stored in the traffic control system in order to provide current even if not real-time information. Such periodic updates may include information about weather, construction on the roadway, traffic accidents, and special events that may alter standard traffic patterns. While this information may be periodically updated, it may be possible to update this information in real-time where possible in some embodiments.

While much of the present disclosure has focused on stoplights as exemplary traffic control mechanisms, the techniques described herein may be applicable to other traffic control mechanisms in various embodiments. As an example, vehicle information may be processed to determine when a reversible lane should change directions. This determination may be made to allow the reversible lane to flow in the direction of greatest traffic flow at any point in time. As another example, vehicle information may be processed to determine the duration of a flow control light on a highway on ramp. This determination may be made so as to balance a reduction in congestion on the highway with a desire to avoid gridlock on the side streets feeding into the on ramp. As another example, vehicle information may be processed to determine how high occupancy vehicle (HOV) restrictions should be applied for an express lane. This determination may be made so as to extend the duration of the HOV restriction (such as a requirement for two or more occupants in a vehicle) as long as a minimal threshold of such vehicles are entering the express lane for a period of time. This determination may be made so as to adjust the minimum number of occupants required for entrance into HOV lanes (such as from HOV 2+ to HOV 3+) based on how many candidate vehicles are present at each occupancy level. As another example, vehicle information may be processed to determine tolls to be set on high occupancy toll (HOT) lanes. This determination may be made so as to increase and decrease tolls for the HOT lanes in real-time so as to have a moderate flow of traffic through the HOT lanes, i.e., not having so much traffic flow that the HOT lanes slow below the posted speed limit but not having so little traffic flow that capacity of the HOT lanes is wasted. As another example vehicle information may be processed to determine when turn restrictions should be activated for various lanes. This determination may be made so as to activate a “no left turn” restriction for a lane when traffic has built up in that lane waiting for the left turn to a point that gridlock or other unacceptable congestion may occur. As another example, vehicle information may be processed to determine a variable speed limit for a road segment at a point in time. This determination may be made so as to set the variable speed limit to the highest possible speed limit that is both safe and likely to be sustainable on the road segment based on present congestion on the road segment. Various other forms of controlling traffic control mechanisms may be performed consistent with the present disclosure.

While the present disclosure has focused on information provided for vehicles traveling in a transit system, the traffic control system may receive information from other actors traveling through the transit system in some embodiments. For example, to the extent that pedestrians may affect traffic flow at intersections (such as with activation of cross signals), information about pedestrians may be processed by the traffic control system in order to determine flow control information. This information about pedestrians may include location, velocity, GPS routes, historic traffic patterns, etc. As another example, information about bicyclists, skaters, joggers, and other individuals traveling through the transit system may be received and processed by the traffic control system along with the vehicle information.

In some embodiments, the vehicle information may be used for emergency services and/or law enforcement purposes. For example, when law enforcement officials are searching for a particular vehicle based on a witness report at a scene of a crime, the vehicle information received by the traffic control system may be used to locate such vehicles. As another example, when an Amber Alert is issued for a geographical area and has an associated vehicle description for a person of interest, the vehicle information received by the traffic control system may be used to locate such vehicles.

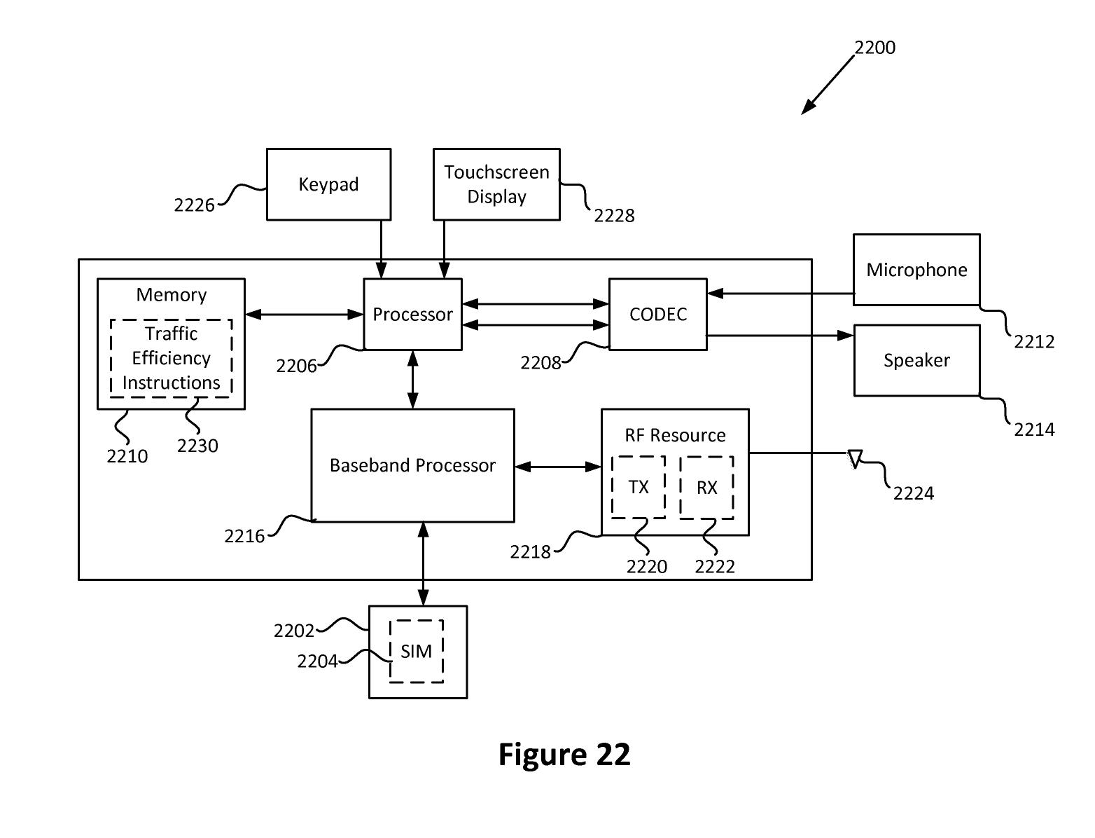

FIG. 22 is a functional block diagram of a mobile device 2200 according to various embodiments of the disclosure. In some embodiments, mobile device 2200 may be used as a mobile device as described previously herein.

Mobile device 2200 may include an identity module interface 2202. Identity module interface 2202 may receive an identity module 2204 associated with a subscription for a user of the mobile device 2200. In some embodiments, identity module interface 2202 may be a subscriber identity module (SIM) interface and identity module 2204 may be a SIM card.

Mobile device 2200 may include at least one processor 2206. In some embodiments, processor 2206 may be provided as a general purpose processor. Processor 2206 may include any suitable data processing device, such as a general purpose processor (e.g., a microprocessor). In the alternative, processor 2206 may be any suitable electronic processor, controller, microcontroller, or state machine. Processor 2206 may also be implemented as a combination of computing devices, e.g., a combination of a DSP and a microprocessor, a plurality of microprocessors, at least one microprocessor in conjunction with a DSP core, or any other such configuration.

Mobile device 2200 may include a coder/decoder (CODEC) 2208 coupled to processor 2206. CODEC 2208 may in turn be coupled to one or more user interface devices. The user interface device may include a display and a user input device. In various embodiments, the display may include any suitable device that provides a human-perceptible visible signal, audible signal, tactile signal, or any combination thereof. The display may include, but is not limited to, a touchscreen, LCD, LED, CRT, plasma, other suitable display screen, audio speaker 2214, other audio generating device, combinations of the preceding, and the like. In various embodiments, the user input device may include any suitable device that receives input from the user. The user input device may include, but is not limited to, one or more manual operators (such as, but not limited to a switch, button, touchscreen, knob, slider, or the like), microphone 2212, camera, image sensor, combinations of the preceding, and the like.

Mobile device 2200 may include at least one memory 2210 coupled to processor 2206. Memory 2210 may be a non-transitory processor-readable storage medium that stores processor-executable instructions. This medium may include, but is not limited to, random access memory (“RAM”), read only memory (“ROM”), floppy disks, hard disks, dongles, USB connected memory devices, combinations of the preceding, or the like. Memory 2210 may store an operating system (“OS”) as well as user application software and executable instructions.

Mobile device 2200 may include at least one baseband processor 2216 coupled to processor 2206. Baseband processor 2216 may be a baseband modem processor. Each identity module in mobile device 2200 (e.g., identity module 2204) may be associated with baseband-RF resources. The RF resources may include at least one baseband-RF resource chain. The baseband-RF resource chain may include baseband processor 2216, which may perform baseband/modem functions for communications on identity module 2204. The baseband-RF resource chain may also include one or more amplifiers and radios, such as RF resource 2218. RF resource 2218 may be a transceiver that performs transmit/receive functions for the mobile device 2200. RF resource 2218 may include transmitter 2220 and receiver 2222. RF resource 2218 may include separate transmit and receive circuitry, or it may include a transceiver that combines transmitter and receiver circuitry. RF resource 2218 may be coupled to a wireless antenna 2224 for transmitting and receiving wireless signals across a wireless medium. RF resource 2218 may further be coupled to baseband processor 2216.

In some embodiments, processor 2206, memory 2210, baseband processor 2216, and RF resource 2218 may be included in mobile device 2200 as a system-on-chip. In some embodiments, identity module 2204 and identity module interface 2202 may be external to the system-on-chip. Further, various input and output devices may be coupled to components on the system-on-chip, such as interfaces or controllers. Example user input components suitable for use in the mobile device 2200 may include, but are not limited to, a keypad 2226, touchscreen display 2228, and microphone 2212.

In some embodiments, keypad 2226, touchscreen display 2228, microphone 2212, or a combination thereof may receive a request to initiate an outgoing call. For example, touchscreen display 2228 may receive a selection of a contact from a contact list or receive a telephone number. As another example, the request to initiate the outgoing call may be in the form of a voice command received via microphone 2212. Interfaces may be provided between the various software modules and functions in the mobile device 2200 to enable communication between them, as is known in the art.

In some embodiments (not shown), mobile device 2200 may include, among other things, additional identity modules (e.g., additional SIM cards), additional identity module interfaces (e.g., additional SIM interfaces), a plurality of RF resources, and additional antennae for connecting to additional mobile networks.

In particular embodiments, memory 2210 may be configured to store processor-executable instructions for performing various features related to the present disclosure, such as traffic efficiency instructions 2230.

In particular embodiments, traffic efficiency instructions 2230 may be effective to cause mobile device 2200 to transmit vehicle information to one or more servers. For example, upon receiving information about a current location and a current velocity for a vehicle in which the mobile device 2200 is located, traffic efficiency instructions 2230 may cause mobile device 2200 to transmit the location and velocity information using RF resource 2218, transmitter 2220, and wireless antenna 2224. As another example, upon receiving GPS data using a GPS receiver of mobile device 2200, such as receiver 2222, traffic efficiency instructions 2230 may cause mobile device 2200 to calculate a current location and current velocity using the GPS data and then transmit the location and velocity information using RF resource 2218, transmitter 2220, and wireless antenna 2224. As another example, upon receiving state change information for one or more traffic control mechanisms using RF resource 2218, receiver 2222, and wirelesses antenna 2224, traffic efficiency instructions 2230 may cause mobile device 2200 to transmit, information using RF resource 2218, transmitter 2220, and wireless antenna 2224, the traffic control mechanism to an electronic device provided in the vehicle for controlling the operation of the vehicle.

In particular embodiments, traffic efficiency instructions 2230 may be effective to cause mobile device 2200 to perform various parts of exemplary processes described elsewhere in the present disclosure.

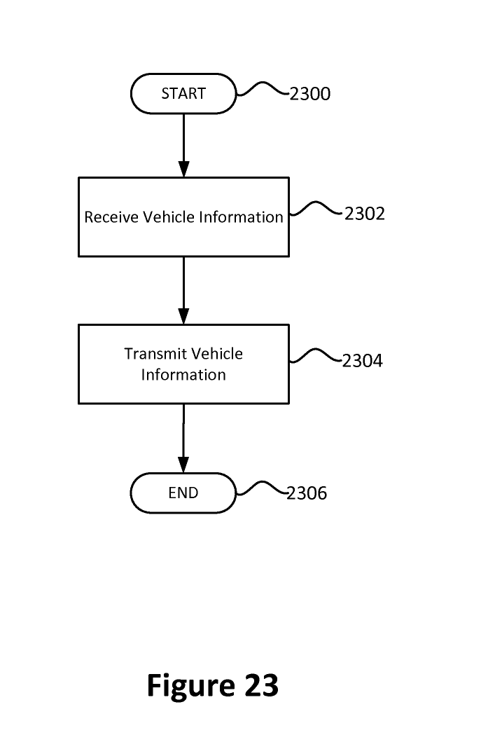

FIG. 23 is a flow chart of a process for traffic efficiency according to various embodiments of the disclosure. The process begins at block 2300.

At block 2302, vehicle information is received. A device located in a vehicle, such as mobile device 132, may perform this block. The vehicle information may include various types of information about the vehicle. The vehicle information may be received via various wireless and wired communications links from various devices or modules present in the vehicle, such as module 122 or GPS device 124. The vehicle information may be received from various devices or modules present in the mobile device 132, such as a GPS module present in the mobile device 132.

At block 2304, vehicle information is transmitted. A device located in a vehicle, such a mobile device 132, may perform this block. The vehicle information may include various types of information about the vehicle. The vehicle information may be transmitted via a communications network, such as communications network 140, to another computing device, such as traffic control server 150. The vehicle information may be transmitted by the mobile device 132 in order to have the vehicle information processed at traffic control server 150 in order to determine flow control information. The vehicle information may be transmitted by the mobile device 132 in order to have one or more traffic control mechanisms controlled based on the flow control information determined based on processing the transmitted vehicle information. In this way, the mobile device 132 may transmit vehicle information in order to allow performance of various parts of exemplary processes described elsewhere in the present disclosure.

At block 2306, the process ends.

In an aspect, a mobile device apparatus for managing traffic efficiency includes means for receiving vehicle information for a vehicle traveling in a transit system. For example, the means for receiving vehicle information may be the receiver 2222 and the antenna 2224 of the mobile device 2200 shown in FIG. 22. A mobile device apparatus for managing traffic efficiency further includes means for transmitting, over one or more communications networks, the vehicle information from the mobile device apparatus to one or more remote servers that are configured to control one or more traffic control mechanisms based on the vehicle information. For example, the means for transmitting the vehicle information may be the transmitter 2220 and the antenna 2224 of the mobile device 2200 shown in FIG. 22.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality is implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

1. A method of managing traffic efficiency, the method comprising:
receiving, at one or more mobile devices, vehicle information for one or more vehicles traveling in a transit system, the one or more mobile devices located in the one or more vehicles; and
transmitting, over one or more communications networks, the vehicle information from the one or more mobile devices to one or more remote servers that are configured to control one or more traffic control mechanisms based on the vehicle information.

2. The method of claim 1,
wherein the vehicle information comprises a current location and a current velocity for each of the one or more vehicles.

3. The method of claim 2,
wherein the current location and the current velocity for each of the one or more vehicles is determined based on a positioning system module provided in each of the one or more mobile devices.

4. The method of claim 3,
wherein the one or more traffic control mechanisms are controlled to reduce a total waiting time for all vehicles of the one or more vehicles.

5. The method of claim 3,
wherein the one or more traffic control mechanisms are controlled to prevent gridlock in at least one intersection in the transit system.

6. The method of claim 1,
wherein the vehicle information comprises a current number of occupants for each of the one or more vehicles.

7. The method of claim 6,
wherein the one or more traffic control mechanisms are controlled to reduce a total waiting time for all occupants in all vehicles of the one or more vehicles.

8. The method of claim 7,
wherein the current number of occupants for each of the one or more vehicles is determined based on the total number of mobile devices in each of the one or more vehicles.

9. The method of claim 1,
wherein the vehicle information comprises fuel consumption information for each of the one or more vehicles.

10. The method of claim 9,
wherein the one or more traffic control mechanisms are controlled to reduce a total amount of fuel consumption for all vehicles of the one or more vehicles.

11. A mobile device apparatus for managing traffic efficiency, the mobile device apparatus comprising:
a receiver configured to receive, at the mobile device apparatus, vehicle information for a vehicle traveling in a transit system, the mobile device apparatus located in the vehicle; and
a transmitter configured to transmit, over one or more communications networks, the vehicle information from the mobile device apparatus to one or more remote servers that are configured to control one or more traffic control mechanisms based on the vehicle information.

12. The mobile device apparatus of claim 11,
wherein the vehicle information comprises a current location and a current velocity for the vehicle.

13. The mobile device apparatus of claim 12,
wherein the current location and the current velocity for the vehicle is determined based on a positioning system module provided in the mobile device apparatus.

14. The mobile device apparatus of claim 13,
wherein the one or more traffic control mechanisms are controlled to reduce a total waiting time for a plurality of vehicles traveling in the transit system.

15. The mobile device apparatus of claim 13,
wherein the one or more traffic control mechanisms are controlled to prevent gridlock in at least one intersection in the transit system.

16. The mobile device apparatus of claim 11,
wherein the vehicle information comprises a current number of occupants for the vehicle.

17. The mobile device apparatus of claim 16,
wherein the one or more traffic control mechanisms are controlled to reduce a total waiting time for all occupants in a plurality of vehicles traveling in the transit system.

18. The mobile device apparatus of claim 17,
wherein the current number of occupants for the vehicle is determined based on the total number of mobile devices in the vehicle.

19. The mobile device apparatus of claim 11,
wherein the vehicle information comprises fuel consumption information for the vehicle.

20. The mobile device apparatus of claim 19,
wherein the one or more traffic control mechanisms are controlled to reduce a total amount of fuel consumption for a plurality of vehicles traveling in the transit system.

21. A mobile device apparatus for managing traffic efficiency, the mobile device apparatus comprising:
means for receiving, at the mobile device apparatus, vehicle information for a vehicle traveling in a transit system, the mobile device apparatus located in the vehicle; and
means for transmitting, over one or more communications networks, the vehicle information from the mobile device apparatus to one or more remote servers that are configured to control one or more traffic control mechanisms based on the vehicle information.

22. The mobile device apparatus of claim 21,
wherein the vehicle information comprises a current location and a current velocity for the vehicle.

23. The mobile device apparatus of claim 22,
wherein the current location and the current velocity of the vehicle is determined based on a positioning system module provided in the mobile device apparatus.

24. The mobile device apparatus of claim 23,
wherein the one or more traffic control mechanisms are controlled to reduce a total waiting time for a plurality of vehicles traveling in the transit system.

25. The mobile device apparatus of claim 21,
wherein the vehicle information comprises a current number of occupants for the vehicle.

26. A non-transitory computer-readable medium comprising instructions configured to cause one or more computing devices to:
receive, at one or more mobile devices, vehicle information for one or more vehicles traveling in a transit system, the one or more mobile devices located in the one or more vehicles; and
transmit, over one or more communications networks, the vehicle information from the one or more mobile devices to one or more remote servers that are configured to control one or more traffic control mechanisms based on the vehicle information.

27. The non-transitory computer-readable medium of claim 26,
wherein the vehicle information comprises a current location and a current velocity for each of the one or more vehicles.

28. The non-transitory computer-readable medium of claim 27,
wherein the current location and the current velocity for each of the one or more vehicles is determined based on a positioning system module provided in each of the one or more mobile devices.

29. The non-transitory computer-readable medium of claim 28,
wherein the one or more traffic control mechanisms are controlled to reduce a total waiting time for all vehicles of the one or more vehicles.

30. The non-transitory computer-readable medium of claim 26,
wherein the vehicle information comprises a current number of occupants for each of the one or more vehicles.
